(19) United States
(12) Patent Application Publication
(10) Pub. No.: US 2010/0328485 A1
(43) Pub. Date: Dec. 30, 2010

(54) IMAGING DEVICE, IMAGING MODULE, ELECTRONIC STILL CAMERA, AND ELECTRONIC MOVIE CAMERA

(75) Inventors: Kunihiro IMAMURA, Osaka (JP); Toshiya FUJII, Shiga (JP); Yoshiyuki MATSUNAGA, Kanagawa (JP)

Correspondence Address: MCDERMOTT WILL & EMERY LLP, 600 13TH STREET, NW, WASHINGTON, DC, 20005-3096, US

(73) Assignee: Panasonic Corporation, Osaka (JP)

(21) Appl. No.: 12/880,551

(22) Filed: Sep. 13, 2010

Related U.S. Application Data
(63) Continuation of application No. PCT/JP2008/003120, filed on Oct. 30, 2008.

(30) Foreign Application Priority Data
Mar. 31, 2008 (JP) 2008-091815

(51) Int. Cl. H04N 5/228; H04N 5/335

(52) U.S. Cl. 348/222.1; 348/308; 348/273; 348/280; 348/279; 348/278; 348/E05.031; 348/E05.091

(57) ABSTRACT

An imaging device includes a plurality of pixels each configured to convert incident light to an electric charge signal and output the electric charge signal as a pixel signal, and a pixel binning unit configured to bin pixel signals from pixels adjacent to each other and output the binned pixel signal. The pixel binning unit performs first pixel binning operation of binning pixel signals from pixels on the same column and second pixel binning operation of binning pixels on the same row.

### CROSS-REFERENCE TO RELATED APPLICATIONS

This is a continuation of PCT International Application PCT/JP2008/003120 filed on Oct. 30, 2008, which claims priority to Japanese Patent Application No. 2008-091815 filed on Mar. 31, 2008. The disclosures of these applications including the specifications, the drawings, and the claims are hereby incorporated by reference in their entirety.

### BACKGROUND

The present disclosure relates to imaging devices which have a large number of pixels having a pixel shift arrangement and in which signals are read out with pixel binning, and imaging modules, electronic still cameras, and electronic movie cameras using the imaging devices.

There is a technique of reading out signals with pixel binning in an imaging device having a large number of pixels having a pixel shift arrangement, thereby increasing the rate of reading of a pixel signal from the imaging device or improving the sensitivity (see, for example, Japanese Patent Publication Nos. 2003-9166 and 2006-211630)

Japanese Patent Publication No. 2003-9166 describes a method of alternately forming a pixel row of alternate green and magenta pixels and a pixel row of alternate cyan and yellow pixels, and performing pixel addition with respect to the green pixels and the cyan or yellow pixels and performing pixel addition with respect to the magenta pixels and the yellow or cyan pixels.

Japanese Patent Publication No. 2006-211630 describes an imaging device including an imaging sensor having a color array which is obtained by rotating a primary color Bayer array by 45 degrees, where four neighboring pixels with the same color including a pixel of interest, which form a square pattern, are binned, and the center of mass of a set of binned pixels is shifted from that of another set of binned pixels (pixel shift arrangement).

### SUMMARY

However, in the pixel binning technique of Japanese Patent Publication No. 2003-9166, the pixel binning pattern is oblique, and therefore, a low-pass filter (LPF) inevitably emerges in both the vertical and horizontal directions, leading to a degradation in the feel of resolution. Moreover, the pixel binning pattern has anisotropy in the oblique direction. Although it is preferable to eliminate the anisotropy by image processing, any process of eliminating the anisotropy would lead to a further degradation in the feel of resolution.

In the pixel binning technique of Japanese Patent Publication No. 2006-211630, the centers of mass of pixels after pixel binning have a pixel shift relationship, whereby the degradation in the resolution can be reduced. However, because the pixels themselves have modulated components caused by the color filters, the actual feel of resolution cannot be significantly improved. Moreover, because a large number of pixels are two-dimensionally binned, a large number of pixels are actually required for outputting of a high-definition moving image, leading to an increase in the size of a camera system or a degradation in the image quality caused by a reduction in the pixel size of an imaging sensor.

In view of the aforementioned problems, the present disclosure has been made. The detailed description describes implementations of an imaging device which has a pixel shift array and in which signals are read out with pixel binning, and in which the resolution is enhanced and the image processing is facilitated, whereby high-definition moving images can be obtained using an imaging sensor having a small number of pixels.

An example imaging device includes a plurality of pixels arranged in a matrix and each configured to convert incident light to an electric charge signal and output the electric charge signal as a pixel signal, a portion of the pixels being shifted in a row direction from another portion of the pixels, and a pixel binning unit configured to bin pixel signals from pixels and output the binned pixel signal. The pixel binning unit performs first pixel binning operation of binning pixel signals from pixels on the same column and second pixel binning operation of binning pixels on the same row.

As a result, pixel signals binned only in the column direction and pixel signals binned only in the row direction can be read out, whereby the rate of reading of pixel signals or the sensitivity can be improved, and the feel of resolution can be improved.

In the example imaging device, the pixel binning unit may bin pixel signals from pixels adjacent to each other in each of the first and second binning operations.

As a result, pixel binning is performed with respect to adjacent pixels, whereby the structure of an imaging sensor can be simplified and the method of driving the imaging sensor can be facilitated, and moreover, the degradation in the feel of resolution due to an LPF caused by pixel binning can be reduced.

In the example imaging device, the pixel binning unit may bin pixel signals so that a center of mass after pixel binning which is formed by the first pixel binning operation coincides with a center of mass after pixel binning which is formed by the first pixel binning operation with respect to pixels which are adjacent to pixels in the pixel binning pattern and are located on a column adjacent to the pixels in the pixel binning pattern, and a center of mass after pixel binning which is formed by the second pixel binning operation coincides with a center of mass after pixel binning which is formed by the second pixel binning operation with respect to pixels which are adjacent to the pixels in the pixel binning pattern and are located on a row adjacent to the pixels in the pixel binning pattern.

As a result, the centers of mass of pixels to be binned form a square pattern, but not a pixel shift pattern. Therefore, the design resources for imaging processing for imaging sensors having a conventional square array can be used.

In the example imaging device, the pixel binning unit may bin pixel signals so that a center of mass after pixel binning which is formed by the first pixel binning operation is shifted by a predetermined number of pixels in a column direction from a center of mass after pixel binning which is formed by the first pixel binning operation with respect to pixels which are adjacent to pixels in the pixel binning pattern and are located on a column adjacent to the pixels in the pixel binning pattern, and a center of mass after pixel binning which is formed by the second pixel binning operation coincides with a center of mass after pixel binning which is formed by the second pixel binning operation with respect to pixels which are adjacent to the pixels in the pixel binning pattern and are located on a row adjacent to the pixels in the pixel binning pattern.

As a result, the centers of mass of pixels to be binned in the column direction form a pixel shift pattern, and the centers of mass of pixels to be binned in the row direction form a square pattern. The feel of resolution can be improved by performing imaging processing by utilizing both of the signal characteristics.

In the example imaging device, the pixel binning unit may bin pixel signals so that a center of mass after pixel binning which is formed by the first pixel binning operation coincides with a center of mass after pixel binning which is formed by the first pixel binning operation with respect to pixels which are adjacent to pixels in the pixel binning pattern and are located on a column adjacent to the pixels in the pixel binning pattern, and a center of mass after pixel binning which is formed by the second pixel binning operation is shifted by a predetermined number of pixels in a row direction from a center of mass after pixel binning which is formed by the second pixel binning operation with respect to pixels which are adjacent to the pixels in the pixel binning pattern and are located on a row adjacent to the pixels in the pixel binning pattern.

As a result, the centers of mass of pixels to be binned in the column direction form a square pattern, and the centers of mass of pixels to be binned in the row direction form a pixel shift pattern. The feel of resolution can be improved by performing imaging processing by utilizing both of the signal characteristics.

In the example imaging device, the pixel binning unit may bin pixel signals so that a center of mass after pixel binning which is formed by the first pixel binning operation is shifted by a predetermined number of pixels in a column direction from a center of mass after pixel binning which is formed by the first pixel binning operation with respect to pixels which are adjacent to pixels in the pixel binning pattern and are located on a column adjacent to the pixels in the pixel binning pattern, and a center of mass after pixel binning which is formed by the second pixel binning operation is shifted by a predetermined number of pixels in a row direction from a center of mass after pixel binning which is formed by the second pixel binning operation with respect to pixels which are adjacent to the pixels in the pixel binning pattern and are located on a row adjacent to the pixels in the pixel binning pattern.

As a result, the centers of mass of pixels to be binned form a pixel shift pattern, but not a square pattern. Therefore, the design resources for imaging processing for imaging sensors having a conventional pixel shift array can be used.

In the example imaging device, the shift in the column direction may be smaller than a distance between the two centers of mass after pixel binning which are formed by the first pixel binning operation and are located side by side in the column direction.

As a result, the centers of mass of pixels to be binned in the column direction form a pixel shift pattern, and the centers of mass of pixels to be binned in the row direction form a square pattern, whereby the centers of mass of the pixel shift pattern are equally spaced. The feel of resolution can be improved by performing imaging processing by utilizing both of the signal characteristics.

In the example imaging device, the shift in the row direction may be smaller than a distance between the two centers of mass after pixel binning which are formed by the second pixel binning operation and are located side by side in the row direction.

As a result, the centers of mass of pixels to be binned in the column direction form a square pattern, and the centers of mass of pixels to be binned in the row direction form a pixel shift pattern, whereby the centers of mass of the pixel shift pattern are equally spaced. The feel of resolution can be improved by performing imaging processing by utilizing both of the signal characteristics.

In the example imaging device, the shift in the column direction may be smaller than a distance between the two centers of mass after pixel binning which are formed by the first pixel binning operation and are located side by side in the column direction, and the shift in the row direction may be smaller than a distance between the two centers of mass after pixel binning which are formed by the second pixel binning operation and are located side by side in the row direction.

As a result, the centers of mass of pixels to be binned form a pixel shift pattern, but not a square pattern, the centers of mass of the pixel shift pattern are equally spaced. Therefore, the design resources for imaging processing for imaging sensors having a conventional pixel shift array can be used.

In the example imaging device, the number of pixels to be binned may be the same in both the first pixel binning operation and the second pixel binning operation.

As a result, the saturation of a signal level of each pixel can be more easily controlled, whereby the structure of image processing can be simplified.

In the example imaging device, the number of pixels to be binned in the first pixel binning operation may be different from the number of pixels to be binned in the second pixel binning operation.

As a result, the control of the saturation of a signal level for each pixel is more complicated. Despite this, by reducing the number of pixels to be binned in a direction in which the resolution needs to be increased, and increasing the number of pixels to be binned in a direction in which the resolution does not need to be increased, the reduction in the resolution deterioration and the improvement in the sensitivity can be simultaneously achieved.

In the example imaging device, the number of pixels to be binned in the first pixel binning operation and the number of pixels to be binned in the second pixel binning operation may be each two.

As a result, a time required to read out pixel signals can be reduced by a half, and moreover, imaging signals in which the degradation in the resolution is significantly reduced can be obtained.

In the example imaging device, a center of mass of pixels in a vertical direction to be read out by the first pixel binning operation may be changed every predetermined vertical blanking interval.

As a result, pixel signals can be read out in an interlaced manner, and moreover, by utilizing a plurality of frame images, an imaging signal having a high resolution can be obtained.

In the example imaging device, a center of mass of pixels in a horizontal direction to be read out by the second pixel binning operation may be changed every predetermined vertical blanking interval.

As a result, by utilizing a plurality of frame images, an imaging signal having a high resolution can be obtained.

In the example imaging device, in the first or second pixel binning operation, reading out of a signal may be skipped for pixels on predetermined rows or columns or at predetermined pixel addresses.

As a result, the rate of reading pixel signals can be further increased than when only pixel binning is performed.

In the example imaging device, a color filter may be provided on each of the pixels.

As a result, color information can be obtained by performing image processing with respect to imaging signals.

In the example imaging device, the color filters may be primary color filters of red, green, and blue.

As a result, imaging signals which are advantageous in terms of the S/N ratio of color signals can be obtained.

In the example imaging device, the color filters may be complementary color filters of at least three of magenta, green, cyan, and yellow.

As a result, imaging signals which are advantageous in terms of sensitivity and resolution can be obtained.

In the example imaging device, for pixels which are located on the 2n-th column (n is an integer of 0 or more) or the (2n+1)th column and on which color filters of the same color are provided, a modulated component of the same color on one of the 2n-th and (2n+1)th columns may be lower than that on the other column, a difference between a maximum transmittance and a minimum transmittance of a normalized filtering characteristic of color filters corresponding to the same color on the 2n-th column may be different from that of color filters corresponding to the same color on the (2n+1)th column, a transmittance with respect to light other than light having a major wavelength of the normalized filtering characteristic of color filters corresponding to the same color on the 2n-th column may be different from that of color filters corresponding to the same color on the (2n+1)th column, or a half-width of a transmittance with respect to light other than light having a major wavelength of a normalized filtering characteristic of color filters corresponding to the same color on the 2n-th column may be different from that of color filters corresponding to the same color on the (2n+1)th column.

As a result, both when signals are read out with pixel binning and when signals are read out without pixel binning, edge components can be detected with high accuracy while color information is obtained at pixels on which a color filter having a low modulated component is provided. The resolution can be improved by image processing using the edge components which have been detected with high accuracy.

In the example imaging device, the color filters may have a gray color, or a luminosity factor characteristic to luminance.

As a result, both when signals are read out with pixel binning and when signals are read out without pixel binning, edge components can be detected, with high accuracy, at pixels on which a color filter having a low modulated component is provided. The resolution can be improved by image processing using the edge components which have been detected with high accuracy.

In the example imaging device, the color filters may have a repeating pattern of a unit array including four pixels. A color filter of a first color may be provided on a reference pixel on the 2n-th line (n is an integer of 0 or more) of the unit array. A color filter of the first color may be provided on a pixel adjacent to the reference pixel in a first horizontal direction on the 2n-the line of the unit array. A color filter of a second color may be provided on a pixel whose center of mass is shifted by a predetermined fraction of a pixel in the first horizontal direction from the reference pixel on the (2n+1)th line of the unit array. A color filter of a third color may be provided on a pixel adjacent in the first horizontal direction to the pixel whose center of mass is shifted by the predetermined fraction of a pixel in the first horizontal direction from the reference pixel on the (2n+1)th line of the unit array.

As a result, the structure of the color filter of the imaging sensor is simplified, whereby the manufacturing cost can be reduced, and moreover, the false color in the column direction can be reduced.

In the example imaging device, the color filters may have a repeating pattern of a unit array including eight pixels. A color filter of a first color may be provided on a reference pixel on the 4n-th line (n is an integer of 0 or more) of the unit array. A color filter of the first color may be provided on a pixel having the same center of mass in a horizontal direction as that of the reference pixel on the (4n+2)th line of the unit array. A color filter of the first color may be provided on a pixel adjacent to the reference pixel in a first horizontal direction on the 4n-the line of the unit array. A color filter of the first color may be provided on a pixel having the same center of mass in the horizontal direction as that of the pixel adjacent to the reference pixel in the first horizontal direction on the (4n+2)the line of the unit array. A color filter of a second color may be provided on a pixel whose center of mass is shifted by a predetermined fraction of a pixel in the first horizontal direction from the reference pixel on the (4n+1)th line of the unit array. A color filter of a third color may be provided on a pixel whose center of mass is shifted by a predetermined fraction of a pixel in the first horizontal direction from the reference pixel on the (4n+3)th line of the unit array. A color filter of the second color may be provided on a pixel adjacent in the first horizontal direction to the pixel whose center of mass is shifted by the predetermined fraction of a pixel in the first horizontal direction from the reference pixel on the (4n+1)th line of the unit array. A color filter of the third color may be provided on a pixel adjacent in the first horizontal direction to the pixel whose center of mass is shifted by the predetermined fraction of a pixel in the first horizontal direction from the reference pixel on the (4n+3)th line of the unit array.

As a result, the structure of the color filter of the imaging sensor is simplified, whereby the manufacturing cost can be reduced, and moreover, the false color in the row direction can be reduced.

In the example imaging device, the color filters may have a repeating pattern of a unit array including 16 pixels. A color filter of a first color may be provided on a reference pixel on the 8n-th column (n is an integer of 0 or more) of the unit array. A color filter of the first color may be provided on a pixel having the same center of mass in a vertical direction as that of the reference pixel on the (8n+2)th column of the unit array. A color filter of the first color may be provided on a pixel having the same center of mass in the vertical direction as that of the reference pixel on the (8n+4)th column of the unit array. A color filter of the first color may be provided on a pixel having the same center of mass in the vertical direction as that of the reference pixel on the (8n+6)th column of the unit array. A color filter of the first color may be provided on a pixel adjacent in a first vertical direction to the reference pixel on the 8n-th column of the unit array. A color filter of the first color may be provided on a pixel adjacent in the first vertical direction to the pixel having the same center of mass in the vertical direction as that of the reference pixel on the (8n+2)th column of the unit array. A color filter of the first color may be provided on a pixel adjacent in the first vertical direction to the pixel having the same center of mass in the vertical direction as that of the reference pixel on the (8n+4)th column of the unit array. A color filter of the first color may be provided on a pixel adjacent in the first vertical direction to the pixel having the same center of mass in the vertical direction as that of the reference pixel on the (8n+6)th column of the unit array. A color filter of a second color may be provided on a pixel which is shifted by a predetermined fraction of a pixel in the first vertical direction from the reference pixel on the (8n+1)th column of the unit array. A color filter of a third color may be provided on a pixel which is shifted by a predetermined fraction of a pixel in the first vertical direction from the reference pixel on the (8n+3)th column of the unit array. A color filter of a fourth color may be provided on a pixel which is shifted by a predetermined fraction of a pixel in the first vertical direction from the reference pixel on the (8n+5)th column of the unit array. A color filter of a fifth color may be provided on a pixel which is shifted by a predetermined fraction of a pixel in the first vertical direction from the reference pixel on the (8n+7)th column of the unit array. A color filter of the fourth color may be provided on a pixel adjacent in the first vertical direction to the pixel which is shifted by the predetermined fraction of a pixel in the first vertical direction from the reference pixel on the (8n+1)th column of the unit array. A color filter of the fifth color may be provided on a pixel adjacent in the first vertical direction to the pixel which is shifted by the predetermined fraction of a pixel in the first vertical direction from the reference pixel on the (8n+3)th column of the unit array. A color filter of the second color may be provided on a pixel adjacent in the first vertical direction to the pixel which is shifted by the predetermined fraction of a pixel in the first vertical direction from the reference pixel on the (8n+5)th column of the unit array. A color filter of the third color may be provided on a pixel adjacent in the first vertical direction to the pixel which is shifted by the predetermined fraction of a pixel in the first vertical direction from the reference pixel on the (8n+7)th column of the unit array.

In the example imaging device, the color filters may have a repeating pattern of a unit array including 16 pixels. A color filter of a first color may be provided on a reference pixel on the 8n-th line (n is an integer of 0 or more) of the unit array. A color filter of the first color may be provided on a pixel having the same center of mass in a horizontal direction as that of the reference pixel on the (8n+2)th line of the unit array. A color filter of the first color may be provided on a pixel having the same center of mass in the horizontal direction as that of the reference pixel on the (8n+4)th line of the unit array. A color filter of the first color may be provided on a pixel having the same center of mass in the horizontal direction as that of the reference pixel on the (8n+6)th line of the unit array. A color filter of the first color may be provided on a pixel adjacent in a first horizontal direction to the reference pixel on the 8n-th line of the unit array. A color filter of the first color may be provided on a pixel having the same center of mass in the horizontal direction as that of the pixel adjacent in the first horizontal direction to the reference pixel on the (8n+2)th line of the unit array. A color filter of the first color may be provided on a pixel having the same center of mass in the horizontal direction as that of the pixel adjacent in the first horizontal direction to the reference pixel on the (8n+4)th line of the unit array. A color filter of the first color may be provided on a pixel having the same center of mass in the horizontal direction as that of the pixel adjacent in the first horizontal direction to the reference pixel on the (8n+6)th line of the unit array. A color filter of a second color may be provided on a pixel which is shifted by a predetermined fraction of a pixel in the first horizontal direction from the reference pixel on the (8n+1)th line of the unit array. A color filter of a third color may be provided on a pixel which is shifted by a predetermined fraction of a pixel in the first horizontal direction from the reference pixel on the (8n+3)th line of the unit array. A color filter of a fourth color may be provided on a pixel which is shifted by a predetermined fraction of a pixel in the first horizontal direction from the reference pixel on the (8n+5)th line of the unit array. A color filter of a fifth color may be provided on a pixel which is shifted by a predetermined fraction of a pixel in the first horizontal direction from the reference pixel on the (8n+7)th line of the unit array. A color filter of the fourth color may be provided on a pixel adjacent in the first horizontal direction to the pixel which is shifted by the predetermined fraction of a pixel in the first horizontal direction from the reference pixel on the (8n+1)th line of the unit array. A color filter of the fifth color may be provided on a pixel adjacent in the first horizontal direction to the pixel which is shifted by the predetermined fraction of a pixel in the first horizontal direction from the reference pixel on the (8n+3)th line of the unit array.

A color filter of the second color may be provided on a pixel adjacent in the first horizontal direction to the pixel which is shifted by the predetermined fraction of a pixel in the first horizontal direction from the reference pixel on the (8n+5)th line of the unit array. A color filter of the third color may be provided on a pixel adjacent in the first horizontal direction to the pixel which is shifted by the predetermined fraction of a pixel in the first horizontal direction from the reference pixel on the (8n+7)th line of the unit array.

As a result, color images can be generated by image processing.

In the example imaging device, for the color filters, the first color may be green, the second color may be cyan, and the third color may be yellow.

As a result, complementary color signals, or binned complementary color signals can be read out as imaging signals. Because a color filter of magenta is not used, the sensitivity can be improved.

In the example imaging device, for the color filters, the first color may be green, the second color may be blue, and the third color may be red.

As a result, primary color signals, or binned primary color signals can be read out as imaging signals, whereby an imaging system which is advantageous in terms of the S/N ratio of color signals and high-speed reading is performed can be provided.

In the example imaging device, for the color filters, the first color may be green, the second color may be green, the third color may be yellow, the fourth color may be magenta, and the fifth color may be cyan.

In the example imaging device, for the color filters, the first color may be green, the second color may be green, the third color may be red, the fourth color may be green, and the fifth color may be blue.

As a result, when signals are read out without pixel binning, processing can be performed as if the camera were a pseudo two-chip camera, whereby the image quality can be improved. When signals are read out with pixel binning, a pixel signal is generated by binning only green signals, whereby the resolution can be improved.

In the example imaging device, color components of color filters for which a first read pixel signal read out by the first pixel binning operation and a second read pixel signal read from a pixel upward or downward adjacent to a pixel of the first read pixel signal by the first pixel binning operation are added, may contain magenta, cyan, green, and yellow at a ratio of 1:1:1:1.

In the example imaging device, color components of color filters for which a first read pixel signal read out by the first pixel binning operation and a second read pixel signal read from a pixel upward or downward adjacent to a pixel of the first read pixel signal by the first pixel binning operation are added, may contain green, red, and blue at a ratio of 2:1:1.

In the imaging device, the ratio of the colors of color filters for which a first read pixel signal read out by the first pixel binning operation and a second read pixel signal read from a pixel upward or downward adjacent to a pixel of the first read pixel signal by the first pixel binning operation are added, may be the same for all signals read out by the first pixel binning operation.

As a result, when the results of the addition of the first and second read pixel signals are compared with those at different neighboring addresses, each addition result can be substantially approximated as a luminance signal. Therefore, modulated color components are cancelled, whereby edge components can be efficiently detected with high accuracy. By performing image processing using the edge components which have been detected with high accuracy, the resolution can be improved.

In the example imaging device, color components of color filters for which a third read pixel signal read out by the second pixel binning operation and a fourth read pixel signal read from a pixel left or right adjacent to a pixel of the first read pixel signal by the second pixel binning operation are added, may contain magenta, cyan, green, and yellow at a ratio of 1:1:1:1.

In the example imaging device, color components of color filters for which a third read pixel signal read out by the second pixel binning operation and a fourth read pixel signal read from a pixel left or right adjacent to a pixel of the first read pixel signal by the second pixel binning operation are added, may contain green, red, and blue at a ratio of 2:1:1.

As a result, when the results of the addition of the third and fourth read pixel signals are compared with those at different neighboring addresses, each addition result can be substantially approximated as a luminance signal. Therefore, modulated color components are cancelled, whereby edge components can be efficiently detected with high accuracy. By performing image processing using the edge components which have been detected with high accuracy, the resolution can be improved.

In the example imaging device, the ratio of the colors of color filters for which a third read pixel signal read out by the second pixel binning operation and a fourth read pixel signal read from a pixel left or right adjacent to a pixel of the first read pixel signal by the second pixel binning operation are added, may be the same for all signals read out by the second pixel binning operation.

As a result, when the results of the addition of the third and fourth read pixel signals are compared with those at different neighboring addresses, modulated color components are cancelled, whereby edge components can be efficiently detected with high accuracy. By performing image processing using the edge components which have been detected with high accuracy, the resolution can be improved.

In the example imaging device, each of the pixels may include one of a CCD, a CMOS, or an NMOS.

As a result, pixel signals are output by pixels each including a CCD, a CMOS, or an NMOS.

The example imaging device may further include a level detector configured to detect a level of a pixel signal read out from each pixel. The pixel binning unit may change the number of pixels to be binned, depending on the pixel signal level detected by the level detector.

As a result, the number of pixels to be binned can be appropriately changed, depending on the brightness of a subject, whereby the resolution and the sensitivity can be simultaneously improved.

In the example imaging device, the pixel binning unit may be configured so that the number of pixels to be binned can be externally changed.

As a result, the priority levels of the read rate and the sensitivity can be externally changed, resulting in a more flexible imaging system.

According to the present disclosure, in an imaging device which has a pixel shift array and from which signals are read out with pixel binning, the resolution can be improved and the image processing is facilitated. As a result, high-definition moving images can be obtained using an imaging sensor having a small number of pixels.

### BRIEF DESCRIPTION OF THE DRAWINGS

FIG. 1 is a block diagram showing a functional configuration of a digital camcorder system according to a first embodiment of the present disclosure.

FIG. 2 is a block diagram showing a configuration of an image sensor in the first embodiment of the present disclosure.

FIG. 3 is a block diagram showing a configuration of a column signal processor in the first embodiment of the present disclosure.

FIG. 4 is a block diagram showing a configuration of a first column controller in the first embodiment of the present disclosure.

FIG. 5 is a block diagram showing a configuration of a second column controller in the first embodiment of the present disclosure.

FIG. 6 is a diagram showing a pixel binning pattern which is used when pixel signals are read out with pixel binning in the first embodiment of the present disclosure.

FIG. 7 is a diagram showing a unit array of a color filter array in the first embodiment of the present disclosure.

FIG. 8 is a diagram showing a variation of the unit array of the color filter array in the first embodiment of the present disclosure.

FIG. 9 is a diagram showing a variation of the unit array of the color filter array in the first embodiment of the present disclosure.

FIG. 10 is a diagram showing a variation of the unit array of the color filter array in the first embodiment of the present disclosure.

FIG. 11 is a diagram showing a variation of the unit array of the color filter array in the first embodiment of the present disclosure.

FIG. 12 is a diagram showing a variation of the unit array of the color filter array in the first embodiment of the present disclosure.

FIG. 13 is a diagram showing a pixel binning pattern which is used when pixel signals are read out with pixel binning in a second embodiment of the present disclosure.

FIG. 14 is a block diagram showing a configuration of a first column controller in the second embodiment of the present disclosure.

FIG. 15 is a diagram showing a pixel binning pattern which is used when pixel signals are read out with pixel binning in a third embodiment of the present disclosure.

FIG. 16 is a diagram showing a variation of the pixel binning pattern which is used when pixel signals are read out with pixel binning in the third embodiment of the present disclosure.

FIG. 17 is a diagram showing a variation of the pixel binning pattern which is used when pixel signals are read out with pixel binning in the third embodiment of the present disclosure.

FIG. 18 is a diagram showing a relationship between the number of pixel signals to be binned and a detection level in a fourth embodiment of the present disclosure.

FIG. 19 is a diagram showing a variation of the unit array of the color filter array in the third embodiment of the present disclosure.

FIG. 20 is a diagram showing a variation of the unit array of the color filter array in the third embodiment of the present disclosure.

### DETAILED DESCRIPTION

Embodiments of the present disclosure will be described hereinafter with reference to the accompanying drawings. Like parts are indicated by like reference characters throughout the specification.

### First Embodiment of the Invention

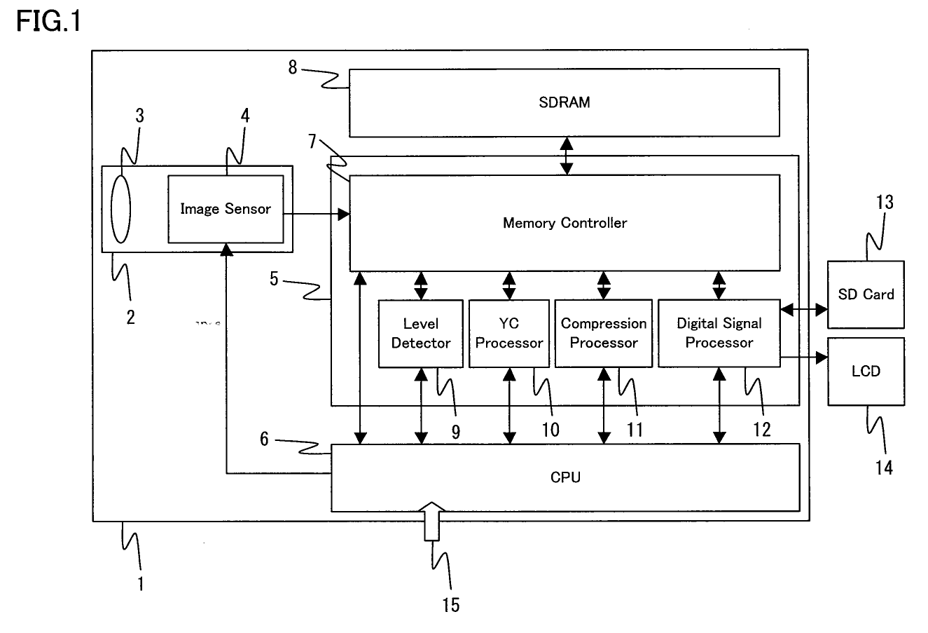

An imaging system according to a first embodiment of the present disclosure will be described. FIG. 1 is a block diagram showing a functional configuration of the imaging system of this embodiment. The imaging system is configured as a digital camcorder 1 (electronic movie camera) including an imaging module 2, a DSP 5, a CPU 6, and an SDRAM 8.

(Configuration of Imaging Module 2)

The imaging module 2 includes a lens 3 and an image sensor 4. Although not shown, the imaging module 2 further includes a timing generator (TG) which generates a control signal required for driving of the image sensor 4.

(DSP 5 and SDRAM 8)

The DSP 5 includes a memory controller 7, a level detector 9, a YC processor 10, a compression processor 11, and a digital signal processor 12. The DSP 5 processes an output from the image sensor 4.

The memory controller 7 writes and saves pixel signals to the SDRAM 8 until the amount of the pixel signals accumulated corresponds to a predetermined number of pixels required for a process in each of the functional blocks, i.e., the level detector 9, the YC processor 10, the compression processor 11, and the digital signal processor 12. The memory controller 7, when necessary, reads the pixel signals from the SDRAM 8 and outputs the pixel signals to the functional blocks, i.e., the level detector 9, the YC processor 10, the compression processor 11, and the digital signal processor 12. The memory controller 7 and the SDRAM 8 also write and read not only pixel signals, but also luminance signals or color signals obtained by YC processing, encoded data obtained by compression, and the like.

Next, the level detector 9 will be described. The level detector 9 calculates a pixel signal level from an average value or the like of pixels signals of the entire screen or a part of the screen which are output from the image sensor 4, and notifies the CPU 6 of the result of the calculation.

Next, the YC processor 10 will be described. The YC processor 10 performs synchronization, filtering, frequency correction, and the like with respect to pixel signals output from the image sensor 4, to generate luminnce signals and color difference signals.

Next, the compression processor 11 will be described. The compression processor 11 compresses pixel signals output from the image sensor 4 at the RAW data level. The compression processor 11 also compresses (encodes) luminance signals and color difference signals generated by the YC processor 10 using a format (JPEG) for still images or another format (H.264) for moving images.

Next, the digital signal processor 12 will be described. The digital signal processor 12 reads and writes data from and to an SD card 13 which is a recording medium connected externally. The digital signal processor 12 also displays an image, such as a preview image or the like, on an LCD 14 which is a display medium. The digital signal processor 12 also performs an enlargement/reduction process (zooming) for adjusting an angle of view, and the like.

(Configuration of CPU 6)

Next, the CPU 6 will be described.

For example, the CPU 6 switches between a mode in which pixel signals are read out with pixel binning and a mode in which pixel signals are read out without pixel binning, for each of the functional blocks provided in the imaging module 2 and the DSP 5, sets a parameter for image processing in the YC processor 10, and the like. Note that an external input 15 is an input externally from a shutter-release button or an external input for setting operation of the digital camcorder 1.

(Configuration of Image Sensor 4)

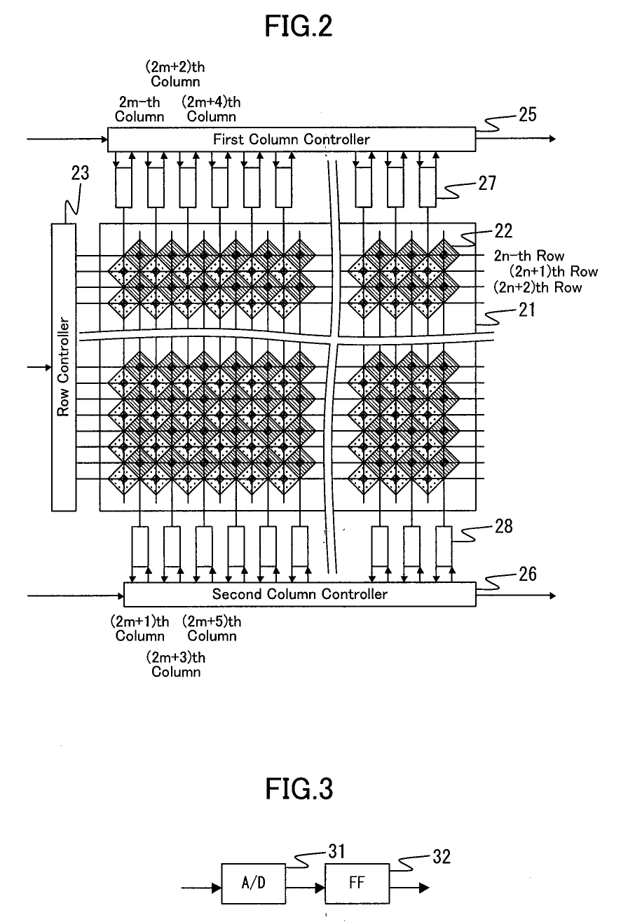

Next, the image sensor 4 will be described. FIG. 2 is a block diagram showing a configuration of the image sensor 4. As shown in FIG. 2, the image sensor 4 includes a pixel array 21, a row controller 23, a first column controller 25, a second column controller 26, first column signal processors 27, and second column signal processors 28. Of these components, the first column controller 25, the second column controller 26, the first column signal processors 27, and the second column signal processors 28 constitute a pixel binning unit.

The pixel array 21 includes a plurality of pixels 22 arranged in a matrix. Specifically, in the pixel array 21, the center of mass of each of pixels 22 on the (2n+1)th line is shifted by half a pixel from that of the corresponding one of pixels 22 on the 2n-th line.

The row controller 23 controls exposure and row-direction read operation with respect to each pixel 22 in the pixel array 21.

The first column signal processors 27 process imaging signals generated by pixels 22 on the 2m-th columns (m is an integer of 0 or more). The second column signal processors 28 process imaging signals generated by pixels 22 on the (2m+1)th columns. As shown in FIG. 3, the first and second column signal processors 27 and 28 each include an A/D converter 31 and a flip-flop 32 (abbreviated to A/D and FF, respectively, in FIG. 3). As a result, the first column signal processors 27 each convert an analog imaging signal read from a corresponding pixel 22 on the (2n+1)th row to a digital signal using the A/D converter 31 before latching the digital signal using the flip-flop 32. The second column signal processors 28 each convert an analog imaging signal read from a corresponding pixel 22 on the 2n-th row to a digital signal using the A/D converter 31 of FIG. 3 before latching the digital signal using the flip-flop 32.

The first and second column controllers 25 and 26 are connected to the first and second column signal processors 27 and 28, respectively. The first and second column controllers 25 and 26 control read operation in the column direction to output imaging signals from the image sensor 4.

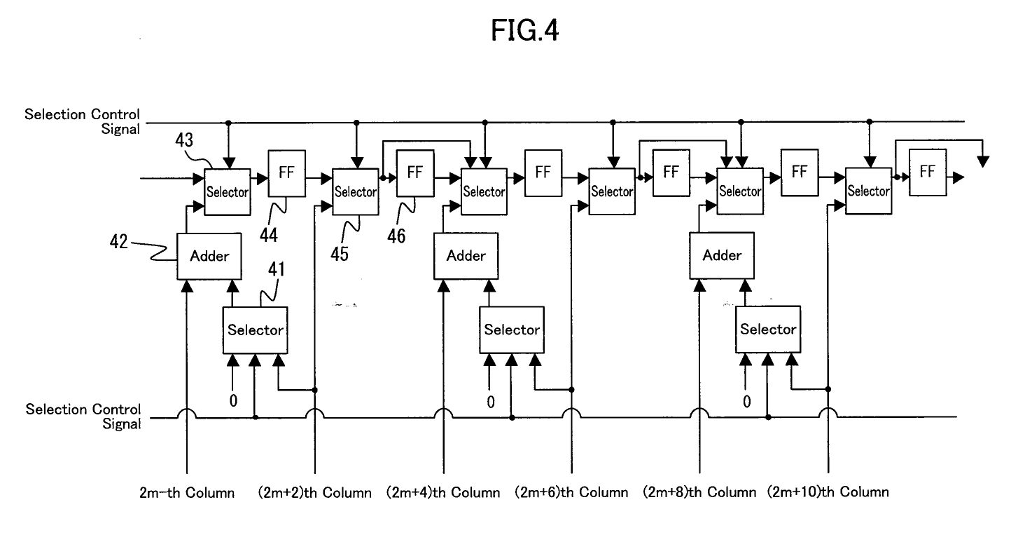

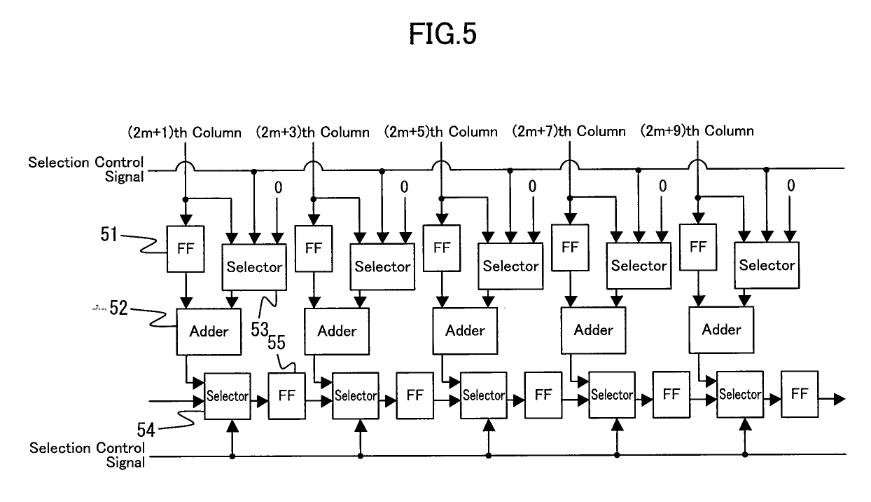

The first column controller 25 may have a configuration shown in FIG. 4, for example. In this example, the first column controller 25 includes a selector 41, an adder 42, a selector 43, a flip-flop (abbreviated to FF in FIG. 4) 44, a selector 45, and a flip-flop 46 for each first column signal processor 27 connected thereto. Similarly, the second column controller 26 may have a configuration shown in FIG. 5, for example. In this example, the second column controller 26 includes a flip-flop (abbreviated to FF in FIG. 5) 51, an adder 52, a selector 53, a selector 54, and a flip-flop (abbreviated to FF in FIG. 5) 55 for each second column signal processor 28 connected thereto.

(Color Filters of Image Sensor 4)

Next, color filters provided on the pixels 22 of the image sensor 4 of this embodiment will be described.

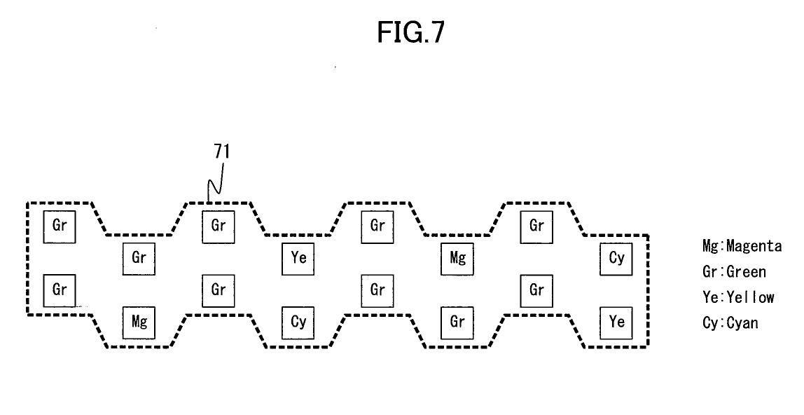

FIG. 7 is a diagram for describing the color filters provided on the pixels 22 of the image sensor 4 of this embodiment. The color filters have a repeating pattern of a unit array 71.

In the aforementioned case where pixel signals are read out without pixel binning, incident light from a subject is filtered by the color filters, then converted to electronic charge signals by the pixels 22, and then read out as pixel signals of magenta (Mg), cyan (Cy), yellow (Ye), and green (Gr).

On the other hand, in the aforementioned case where pixel signals are read out with pixel binning, incident light from a subject is filtered by the color filters, and then converted to electronic charge signals by the pixels 22, which are pixel signals of magenta (Mg), cyan (Cy), yellow (Ye), and green (Gr).

When all the color filters on the 2n-th row are Gr, Mg and Gr are added and Ye and Cy are added in the column direction by the first column controller 25, and Gr and Gr are added in the row direction by the second column controller 26, so that pixel signals are binned and output in pairs, i.e., Mg+Gr, Ye+Cy, and Gr+Gr. In other words, pixel signals (Mg and Gr in this example) on predetermined columns which are binned by the first column controller 25, and pixel signals (Ye and Cy corresponding to the Mg and Gr) adjacent to those pixel signals in the left or right direction, have magenta (Mg), cyan (Cy), green (Gr), and yellow (Ye) components at the ratio of 1:1:1:1.

When all the color filters on the (2n+1)th row are Gr, Gr and Gr are added in the column direction by the first column controller 25, and Gr and Ye are added and Mg and Cy are added in the row direction by the second column controller 26, so that pixel signals are binned and output in pairs, i.e., Gr+Gr, Gr+Ye, and Mg+Cy. In other words, pixel signals (Gr and Ye in this example) on predetermined columns which are binned by the second column controller 26, and pixel signals (Mg and Cy corresponding to the Gr and Ye) adjacent to those pixel signals in the left or right direction, have magenta (Mg), cyan (Cy), green (Gr), and yellow (Ye) components at the ratio of 1:1:1:1.

<<Operation of Digital Camcorder 1 (Imaging System)>>

(Overall Operation)

When shooting is performed by the digital camcorder 1, light from a subject is passed through the lens 3 to enter the image sensor 4, converted to electric charge signals by the pixels 22 on the image sensor 4, and output as an imaging signal to the DSP 5.

The imaging signal is read from or written to the SDRAM 8 via the memory controller 7. The imaging signal is also input to or output from the level detector 9, the YC processor 10, the compression processor 11, the digital signal processor 12, the SD card 13 (recording medium), and the LCD 14 (display medium) via the memory controller 7.

The level detector 9 detects a level of the imaging signal and notifies the CPU 6 of the imaging signal level.

The YC processor 10 performs filtering, synchronization, and the like with respect to the imaging signal to convert the imaging signal to a YC signal.

The compression processor 11 reduces the data amount of the imaging signal or the YC signal using a compression format (JPEG, etc.) for still images or another compression format (H.264, etc.) for moving images.

The digital signal processor 12 performs signal processing required for operation of camcorders, such as zooming, defect correction, detection of the color temperature of illumination light, and the like.

On the other hand, the CPU 6 outputs a control signal required for operation of the digital camcorder 1 expected by the user, to the image sensor 4, and the functional blocks of the DSP 5.

(Driving of Image Sensor 4 and Operation of Column Controllers 25 and 26)

A method for driving the image sensor 4 when the image sensor 4 outputs a video signal as described above will be described. As described above, the image sensor 4 has two types of operation, i.e., the operation in which pixel signals are read out without pixel binning and the operation in which pixel signals are read out with pixel binning.

Pixel Signal Read Operation Without Pixel Binning

Firstly, the case where pixel signals are read out without pixel binning will be described.

After exposure is performed with respect to the pixels 22 for a predetermined exposure time, the row controller 23 outputs to the pixels 22 on the (2n+1)th row a row select signal for reading out imaging signals. As a result, in accordance with the row select signal, it is determined that imaging signals accumulated in the pixels 22 on the (2n+1)th row are to be read out. Moreover, the first column controller 25 outputs a column select signal, so that the imaging signals in the pixels 22 on the (2n+1)th row are output to the first column signal processors 27.

The first column signal processors 27 convert the analog imaging signals read from the pixels 22 on the (2n+1)th row to digital signals using the A/D converters 31 before latching the digital signals using the flip-flops 32.

The resultant digital imaging signals originated from the pixels 22 on the (2n+1)th row are transferred by the first column controller 25, which outputs the digital imaging signals as output signals of the image sensor 4.

In this case, by inputting a selection control signal so that the outputs of the selectors 41 invariably have a value of zero, one of the inputs of each of the adders 42 is invariably zero. As a result, to pixel signals on columns of interest, pixel signals on the other columns are not added, so that only pixel signals of the 4m-th columns are input to the selectors 43, and only pixel signals of the (4m+2)th columns are input to the selectors 45.

Every horizontal blanking interval, by controlling the selection control signals to the selectors 43 and the selectors 45 during a predetermined period so that the outputs of the adders 42 and the outputs of the (4m+2)th columns are the outputs of selectors 43 and the outputs of the selectors 45, respectively, the pixel signals of the 4m-th columns and the pixel signals of the (4m+2)th columns are input to the flip-flops 44 and the flip-flops 46, respectively.

Thereafter, by controlling the selection control signals so that the outputs of the selectors 43 and the outputs of the selectors 45 are the outputs of the flip-flops 46 and the outputs of the flip-flops 44, respectively, the flip-flops 44 and 46 are sequentially coupled. Therefore, pixel signals of the 2m-th columns can be read out by applying clocks to perform shift operation.

In parallel with this operation, the row controller 23 outputs to the pixels 22 on the 2n-th row a row select signal for reading out imaging signals. In accordance with the row select signal, it is determined that imaging signals accumulated in the pixels 22 on the 2n-th row are to be read out.

Further, the second column controller 26 outputs a column select signal, so that the imaging signals in the pixels 22 on the 2n-th row are output to the second column signal processors 28. The second column signal processors 28 convert the analog imaging signals read from the pixels 22 on the 2n-th row to digital signals using the A/D converters 31 of FIG. 3 before latching the digital signals using the flip-flops 32.

The resultant digital imaging signals originated from the pixels 22 on the 2n-th row are transferred by the second column controller 26 of FIG. 5, which outputs the digital imaging signals as output signals of the image sensor 4. In this case, by inputting a selection control signal so that the outputs of the selectors 53 invariably have a value of zero, one of the inputs of each of the adders 52 is invariably zero. As a result, to pixel signals on columns of interest, pixel signals on the other columns are not added, so that pixel signals of the (2m+1)th columns are input to the selectors 54.

Every horizontal blanking interval, by controlling the selection control signal to the selectors 54 during a predetermined period so that the outputs of the adders 52 are the outputs of selectors 54, the pixel signals of the (2m+1)th columns are input to the flip-flops 55.

Thereafter, by controlling the selection control signal so that the outputs of the selectors 54 are the outputs of the flip-flops 55, the flip-flops 55 are sequentially coupled. Therefore, the pixel signals of the (2m+1)th columns can be read out by applying clocks to perform shift operation.

The operation from the outputting of a row select signal from the row controller 23 to the latching of digital imaging signals of pixels 22 by the flip-flops 32 is repeatedly performed while n is incremented every horizontal blanking interval. As a result, imaging signals on each row are read out to the first and second column controllers 25 and 26. By applying the aforementioned control signals to the first and second column controllers 25 and 26, the imaging signals on each row are output from the image sensor 4. By resetting n every vertical blanking interval, imaging signals of the pixel array 21 can be read out.

Read Operation With Pixel Binning

Next, the case where pixel signals are read out with pixel binning will be described.

After exposure is performed with respect to the pixels 22 for a predetermined exposure time, the row controller 23 outputs to the pixels 22 on the (2n+1)th row a row select signal for reading out imaging signals. As a result, in accordance with the row select signal, it is determined that imaging signals accumulated in the pixels 22 on the (2n+1)th row are to be read out.

Further, the first column controller 25 outputs a column select signal, so that the imaging signals in the pixels 22 on the (2n+1)th row are output to the first column signal processors 27. The first column signal processors 27 convert the analog imaging signals read from the pixels 22 on the (2n+1)th row to digital signals using the A/D converters 31 before latching the digital signals using the flip-flops 32.

The resultant digital imaging signals originated from the pixels 22 on the (2n+1)th row are transferred by the first column controller 25 of FIG. 4, which outputs the digital imaging signals as output signals of the image sensor 4. In this case, by inputting a selection control signal so that the outputs of the selectors 41 invariably have values of the (4m+2)th columns, one of the inputs of each of the adders 42 is invariably the value of the corresponding (4m+2)th column. As a result, the pixel signals of the 4m-th and (4m+2)th columns of interest are added, and the results of the addition of the pixel signals are input to the selectors 43.

Every horizontal blanking interval, by controlling the selection control signal to the selectors 43 during a predetermined period so that the outputs of the adders 42 are the outputs of the selectors 43, the results of the addition of the pixel signals of the 4m-th columns and the pixel signals of the (4m+2)th columns are input to the flip-flops 44.

Thereafter, by controlling the selection control signals so that the outputs of the selectors 43 and the outputs of the selectors 45 are the outputs of the flip-flops 44 and the outputs of the flip-flops 46, respectively, the flip-flops 44 and 46 are sequentially coupled. Therefore, the added pixel signals can be read out by applying clocks to perform shift operation.

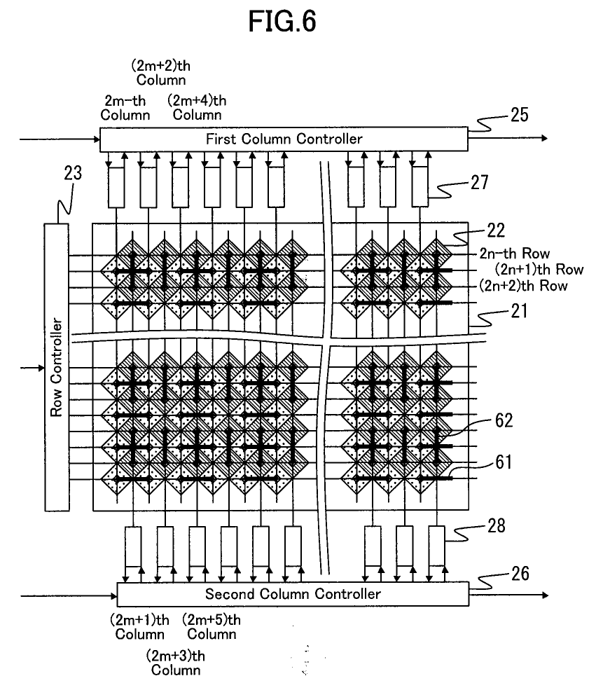

By performing the aforementioned drive operation, pixel binning can be performed in accordance with a pixel binning pattern 61 shown in FIG. 6. In FIG. 6, pixels whose centers of mass are linked with a thick line are ones which are to be binned.

In parallel with this operation, the row controller 23 outputs to the pixels 22 on the 2n-th row a row select signal for reading out imaging signals. In accordance with the row select signal, it is determined that imaging signals accumulated in the pixels 22 on the 2n-th row are to be read out.

Further, the first column controller 25 outputs a column select signal, so that the imaging signals in the pixels 22 on the 2n-th row are output to the second column signal processors 28. The first column signal processors 28 convert the analog imaging signals read from the pixels 22 on the 2n-th row to digital signals using the A/D converters 31 of FIG. 3 before latching the digital signals using the flip-flops 32.

The resultant digital imaging signals originated from the pixels 22 on the 2n-th row are transferred by the second column controller 26 of FIG. 5, which outputs the digital imaging signals as output signals of the image sensor 4. In this case, by inputting a selection control signal so that the outputs of the selectors 53 are invariably the outputs of the flip-flops 32 corresponding to pixel signals of the (2n+2)th row, one of the inputs of each of the adders 52 is invariably the output signal of the corresponding flip-flop 32. As a result, the pixel signals of the 2n-th and (2n+2)th rows of interest are added, and the results of the addition of the pixel signals are input to the selectors 54.

Every horizontal blanking interval, by controlling the selection control signal to the selectors 54 during a predetermined period so that the outputs of the adders 52 are the outputs of the selectors 54, the results of the addition of the pixel signals of the 2n-th row and the pixel signals of the (2n+2)th row are input to the flip-flops 55.

Thereafter, by controlling the selection control signal so that the outputs of the selectors 43 are the outputs of the flip-flops 55, the flip-flops 55 are sequentially coupled. Therefore, the added pixel signals can be read out by applying clocks to perform shift operation.

By performing the aforementioned drive operation, pixel binning can be performed in accordance with a pixel binning pattern 62 shown in FIG. 6. By incrementing the value of n which is selected in accordance with the row select signal every horizontal blanking interval and resetting n every vertical blanking interval, imaging signals of the pixel array 21 can be read out.

As described above, according to this embodiment, a pixel signal obtained by binning pixels in the horizontal direction (row direction binning) and a pixel signal obtained by binning pixels in the vertical direction (column direction binning) can be obtained. As to the pixel signals obtained by the pixel binning, the column direction binning has the same effect as that of a vertical direction LFP, and the row direction binning has the same effect as that of a horizontal direction LPF, resulting in a reduction in the resolution in both the horizontal and vertical directions. However, in this embodiment, two types of pixel signals which are a pixel signal to which the LPF effect is applied only in the vertical direction and a pixel signal to which the LPF effect is applied only in the horizontal direction, constitute the pixel binning pattern. Therefore, the pixel signal in one of the horizontal and vertical direction can always compensate for lost edge information of the pixel signal in the other direction. As a result, the image sensor 4 can reduce the degradation in the resolution. Conventionally, in order to recover information lost due to the LPF effect, pixel information is compensated for by a complicated image process. By contrast, in this embodiment, as described above, edge information can be compensated for using a pixel signal in one of the horizontal and vertical directions, whereby image processing can be facilitated. As a result, a high-definition moving image can be obtained even using an imaging sensor having a small number of pixels.

<<First Variation of First Embodiment>>

In the foregoing description, the color filters provided on the pixels 22 of the (2n+1)th row are all Gr, and Gr and Ye are added and Mg and Cy are added in the row direction by the second column controller 26. Alternatively, Ye and Mg may be added and Gr and Cy may be added.

<<Second Variation of First Embodiment>>

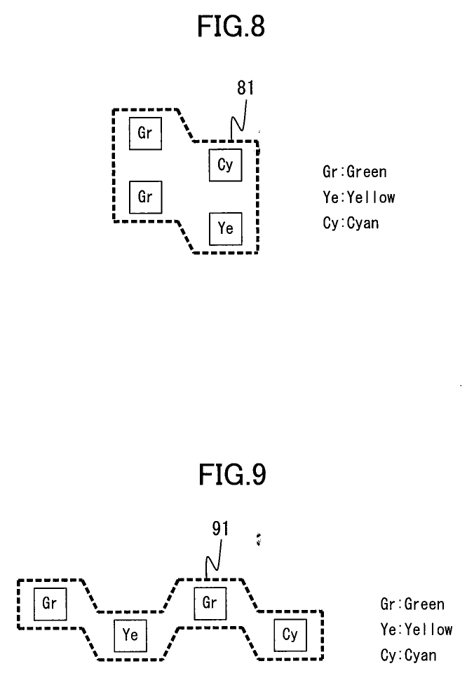

In the foregoing description, the color filters provided on the pixels 22 of the image sensor 4 are arranged as shown in FIG. 7. Alternatively, the color filter array may have a unit array 81 shown in FIG. 8. In the unit array 81, Gr indicates green, Cy indicates cyan, and Ye indicates yellow.

In this case, when signals are read out with pixel binning, rows including only Gr are selected as ones on which addition is performed in the column direction, and the other rows are selected as ones on which addition is performed in the row direction, whereby pixel signals are binned and output in pairs, i.e., Gr+Gr, Ye+Ye, and Cy+Cy. When signals are read out without pixel binning, pixel signals are output as Gr, Cy, and Ye.

<<Third Variation of First Embodiment>>

In the foregoing description, the color filters provided on the pixels 22 of the image sensor 4 are arranged as shown in FIG. 7. Alternatively, the color filter array may have a unit array 91 shown in FIG. 9. In the unit array 91, Gr indicates green, Cy indicates cyan, and Ye indicates yellow.

In this case, when signals are read out with pixel binning, rows including only Gr are selected as ones on which addition is performed in the row direction, and the other rows are selected as ones on which addition is performed in the column direction on the other rows, whereby pixel signals are binned and output in pairs, i.e., Gr+Gr, Ye+Ye, and Cy+Cy. When signals are read out without pixel binning, pixel signals are output as Gr, Cy, and Ye.

<<Fourth Variation of First Embodiment>>

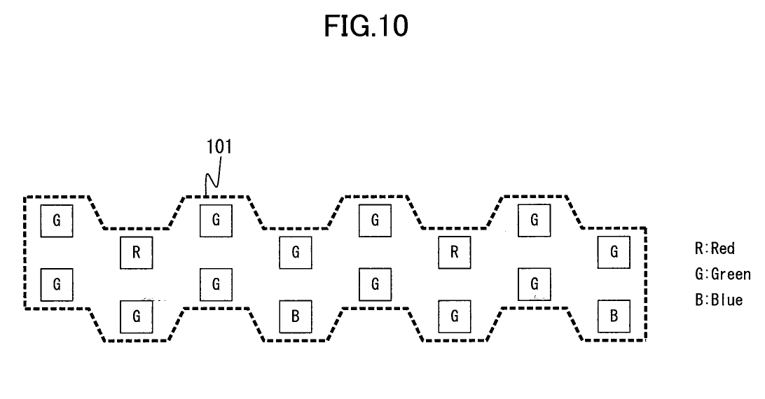

In the foregoing description, the color filters provided on the pixels 22 of the image sensor 4 are arranged as shown in FIG. 7. Alternatively, the color filter array may have a unit array 101 shown in FIG. 10. In the unit array 101, G indicates green, B indicates blue, and R indicates red.

In this case, when signals are read out with pixel binning, rows including only G are selected as ones on which addition is performed in the column direction, and the other rows are selected as ones on which addition is performed in the row direction, whereby pixel signals are binned and output in pairs, i.e., G+G, G+R, and G+B. When signals are read out without pixel binning, pixel signals are output as G, B, and R.

Moreover, when signals are read out with pixel binning, rows including only G are selected as ones on which addition is performed in the row direction, and the other rows are selected as ones on which addition is performed in the column direction, whereby pixel signals are binned and output in pairs, i.e., G+G, G+R, and G+B. When signals are read out without pixel binning, pixel signals are output as G, B, and R.

In other words, pixel signals (G and R in this example) on predetermined columns which are binned in the row direction, and pixel signals (G and B corresponding to the G and R) adjacent to those pixel signals in the left or right direction, have G (green), R (red), and B (blue) components at the ratio of 2:1:1.

<<Fifth Variation of First Embodiment>>

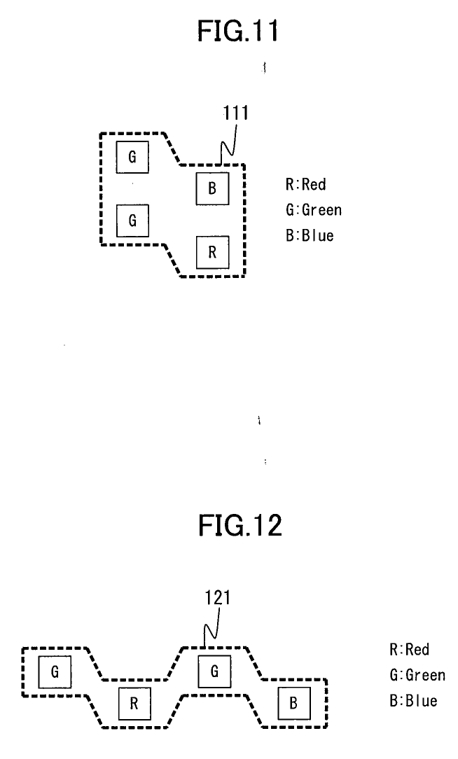

In the foregoing description, the color filters provided on the pixels 22 of the image sensor 4 are arranged as shown in FIG. 7. Alternatively, the color filter array may have a unit array 111 shown in FIG. 11. In the unit array 111, G indicates green, B indicates blue, and R indicates red.

In this case, when signals are read out with pixel binning, rows including only G are selected as ones on which addition is performed in the column direction, and the other rows are selected as ones on which addition is performed in the row direction, whereby pixel signals are binned and output in pairs, i.e., G+G, R+R, and B+B. When signals are read out without pixel binning, pixel signals are output as G, B, and R.

<<Sixth Variation of First Embodiment>>

In the foregoing description, the color filters provided on the pixels 22 of the image sensor 4 are arranged as shown in FIG. 7. Alternatively, the color filter array may have a unit array 121 shown in FIG. 12. In the unit array 121, G indicates green, B indicates blue, and R indicates red.

In this case, when signals are read out with pixel binning, rows including only G are selected as ones on which addition is performed in the row direction, and the other rows are selected as ones on which addition is performed in the column direction, whereby pixel signals are binned and output in pairs, i.e., G+G, R+R, and B+B. When signals are read out without pixel binning, pixel signals are output as G, B, and R.

<<Seventh Variation of First Embodiment>>

In the foregoing description, when pixel signals are read from the pixels 22 on the image sensor 4, the row and column select signals are controlled so that pixel signals are continuously read from all the pixels 22, i.e., pixel binning is performed with respect to the pixels on all rows and all columns before pixel signals are read out. Alternatively, the row and column select signals may be controlled so that pixel signals are intermittently read out, i.e., pixel signals are not read from pixels at predetermined addresses on the pixel array 21, or pixel signals are not read from pixels on predetermined rows or columns.

<<Eighth Variation of First Embodiment>>

In the foregoing description, the exposure time and the frame rate in the case of reading of pixel signals from the pixels 22 on the image sensor 4 are not specified. The exposure time length may differ between when pixel signals are read out with pixel binning in the column direction and when pixel signals are read out with pixel binning in the row direction. The frame rate may differ between when pixel signals are read out with pixel binning in the column direction and when pixel signals are read out with pixel binning in the row direction.

<<Ninth Variation of First Embodiment>>

In the foregoing description, the imaging system is a digital camcorder. Alternatively, the imaging system may be a digital still camera.

### Second Embodiment of the Invention

An imaging system according to a second embodiment of the present disclosure will be described. The imaging system of the second embodiment of the present disclosure is slightly different from that of the first embodiment of the present disclosure. Differences will be mainly described.

(Driving of Imaging Sensor 4 and Column Controllers 25 and 26)

A method for driving the image sensor 4 will be described.

This embodiment is different from the first embodiment only in the case where pixel signals are read out with pixel binning in the column direction. Here, the case will be described.

After exposure is performed with respect to the pixels 22 for a predetermined exposure time, the row controller 23 outputs to the pixels 22 on the 2n-th row a row select signal for reading out imaging signals. In accordance with the row select signal, it is determined that imaging signals accumulated in the pixels 22 on the 2n-th row are to be read out.

Further, the second column controller 26 outputs a column select signal for reading out pixel signals of the (4k+1)th columns, so that the imaging signals in the pixels 22 on the 2n-th row and the (4k+1)th columns are output to the second column signal processors 28. The second column signal processors 28 convert the analog imaging signals read from the pixels 22 on the 2n-th row and the (4k+1)th columns to digital signals using the A/D converters 31 before latching the digital signals using the flip-flops 32.

The resultant digital imaging signals originated from the pixels 22 on the 2n-th row and the (4k+1)th columns are transferred by the second column controller 26 of FIG. 5, which outputs the digital imaging signals as output signals of the image sensor 4. Next, the row controller 23 outputs to the pixels 22 on the (2n+2)th row a row select signal for reading out imaging signals. In accordance with the row select signal, it is determined that imaging signals accumulated in the pixels 22 on the (2n+2)th row are to be read out.

In this case, the second column controller 26 outputs a column select signal so that imaging signals accumulated in the pixels 22 on all the columns are read out, whereby the imaging signals in the pixels 22 on the (2n+2)th row are output to the second column signal processors 28. The second column signal processors 28 convert the analog imaging signals read from the pixels 22 on the (2n+2)th row to digital signals using the A/D converters 31 of FIG. 3 before latching the digital signals using the flip-flops 32.

In this case, by inputting a selection control signal so that the outputs of the selectors 53 on the (4k+1)th columns invariably select outputs of the flip-flops 32 corresponding to the imaging signals of the (2n+2)th row, one of the inputs of each of the adders 52 is invariably the output signal of the corresponding flip-flop 32. As a result, the pixel signals of the 2n-th and (2n+2)th rows on the (4k+1)th columns of interest are added. The results of the addition of the pixel signals are input to the selectors 54, and this state is held until pixel binning is started with respect to pixel signals of the (4k+3)th columns.

In parallel with the hold state of the (4k+1)th columns, the row controller 23 outputs to the pixels 22 on the (2n+4)th row a row select signal for reading out imaging signals.

Further, the second column controller 26 outputs a column select signal for reading out pixel signals of the (4k+3)th columns, so that imaging signals of the pixels 22 on the 2n-th row and the (4k+3)th columns are output to the second column signal processors 28. The second column signal processors 28 convert the analog imaging signals read from the pixels 22 on the (2n+4)th row and the (4k+3)th columns to digital signals using the A/D converters 31 of FIG. 3 before latching the digital signals using the flip-flops 32.

In this case, by inputting a selection control signal so that the selectors 53 on the (4k+3)th columns invariably select the outputs of the flip-flops 32 corresponding to the pixel signals of the (2n+4)th row, one of the inputs of each of the adders 52 is invariably the output signal of the corresponding flip-flop 32. As a result, the pixel signals of the (2n+4)th and the (2n+2)th rows on the (4k+3)th columns of interest are added, and the results of the addition of the pixel signals are input to the selectors 54.

At this stage, each adder 52 outputs the result of the addition of pixel signals on the corresponding column in the column direction. The (4k+1)th columns transition from the hold state to a state for operation of reading pixel signals from the image sensor 4.

After the transition to the pixel signal read operation state, every horizontal blanking interval, by controlling the selection control signal to the selectors 54 during a predetermined period so that the outputs of the adders 52 are the outputs of the selectors 54, the results of the addition of the pixel signals of the 2n-th and (2n+2)th rows on the (4k+1)th columns and the results of the addition of the pixel signals of the (2n+2)th and (2n+4)th rows on the (4k+3)th column are input to the flip-flops 55.

Thereafter, by controlling the selection control signal so that the outputs of the selectors 43 are the outputs of the flip-flops 55, the flip-flops 55 are sequentially coupled. Therefore, the added pixel signals can be read out by applying clocks to perform shift operation.

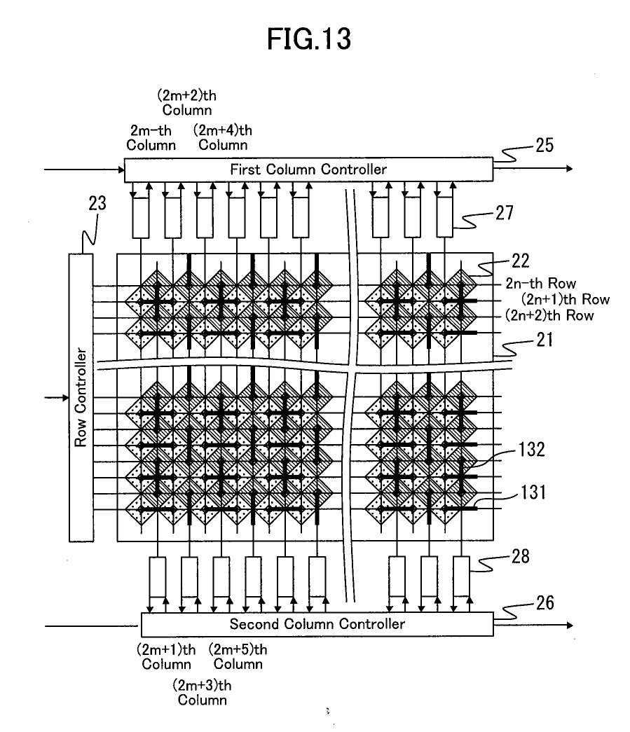

By performing the aforementioned drive operation, pixel binning can be performed in accordance with a pixel binning pattern 132 shown in FIG. 13. By incrementing the value of n which is selected in accordance with the row select signal every horizontal blanking interval and resetting n every vertical blanking interval, imaging signals of the pixel array 21 can be read out.

<<Variation of Second Embodiment>>

In the foregoing description, when pixel signals are read from the pixels 22 on the image sensor 4, the pixel signals are added in the column direction. Alternatively, the operation of adding pixel signals of the (4k+1)th column and the operation of adding the pixel signals of the (4k+3)th column may be switched every predetermined vertical blanking interval.

### Third Embodiment of the Invention

An imaging system according to a third embodiment of the present disclosure will be described. The imaging system of the third embodiment of the present disclosure is slightly different from that of the first embodiment of the present disclosure. Differences will be mainly described.

Driving of Imaging Sensor 4 and Column Controllers 25 and 26

A method for driving the image sensor 4 will be described.

This embodiment is different from the first embodiment only in the case where pixel signals are read out with pixel binning in the column direction. Here, the case will be described.

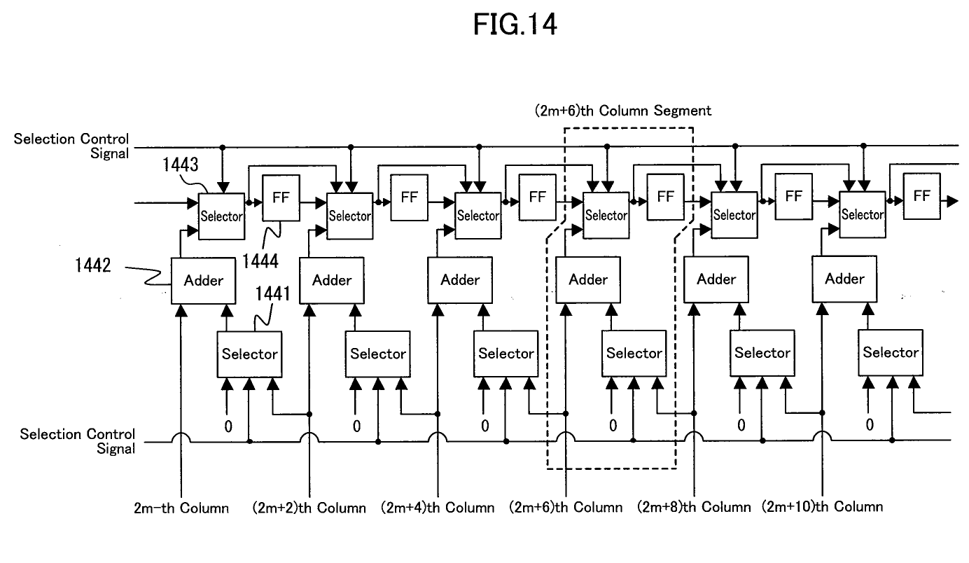

This embodiment is different from the first embodiment in the configuration of the first column controller 25 and the method of operating the first column controller 25. The first column controller 25 of this embodiment has a configuration shown in FIG. 14. The first column controller 25 includes a selector 1441, an adder 1442, a selector 1443, and a flip-flop (abbreviated to FF in FIG. 14) 1444 for each column.

In the image sensor 4, after exposure is performed with respect to the pixels 22 for a predetermined exposure time, the row controller 23 outputs to the pixels 22 on the (2n+1)th row a row select signal for reading imaging signals. In accordance with the row select signal, it is determined that imaging signals accumulated in the pixels 22 on the (2n+1)th row are to be read out. Further, the first column controller 25 outputs a column select signal so that the imaging signals of the pixels 22 on the (2n+1)th row are output to the first column signal processors 27. The first column signal processors 27 convert the analog imaging signals read from the pixels 22 on the (2n+1)th row to digital signals using the A/D converters 31 before latching the flip-flops 32.

The resultant digital imaging signals originated from the pixels 22 on the (2n+1)th row are transferred by the first column controller 25, which outputs the digital imaging signals as output signals of the image sensor 4. In this case, by inputting a selection control signal so that the outputs of the selectors 1441 in the 4m-th column segments invariably have values of the (4m+2)th columns, one of the inputs of each of the adders 1442 in the 4m-th column segments is invariably the value of the corresponding (4m+2)th column. As a result, the pixel signals of the 4m-th and (4m+2)th columns of interest are added. Thereafter, the output results of the adders 1442 in the 4m-th column segments are input to the selectors 1443 in the 4m-th column segments.

Every horizontal blanking interval, by controlling the selection control signal to the selectors 1443 in the 4m-th column segments during a predetermined period so that the outputs of the adders 1442 in the 4m-th column segments are the outputs of selectors 1443 in the 4m-th column segments, the results of the addition of the pixel signals of the 4m-th columns and the pixel signals of the (4m+2)th columns are input to the flip-flops 1444 in the 4m-th column segments.

Thereafter, by controlling the selection control signal so that the outputs of the selectors 1443 in the 4m-th column segments and the outputs of the selectors 1443 in the (4m+2)th column segments are the outputs of the selectors 1443 in the (4m−2)th column segments and the outputs of the flip-flops 1444 in the 4m-th column segments, respectively, the flip-flops 1444 are sequentially coupled. Therefore, the added pixel signals can be read out by applying clocks to perform shift operation.

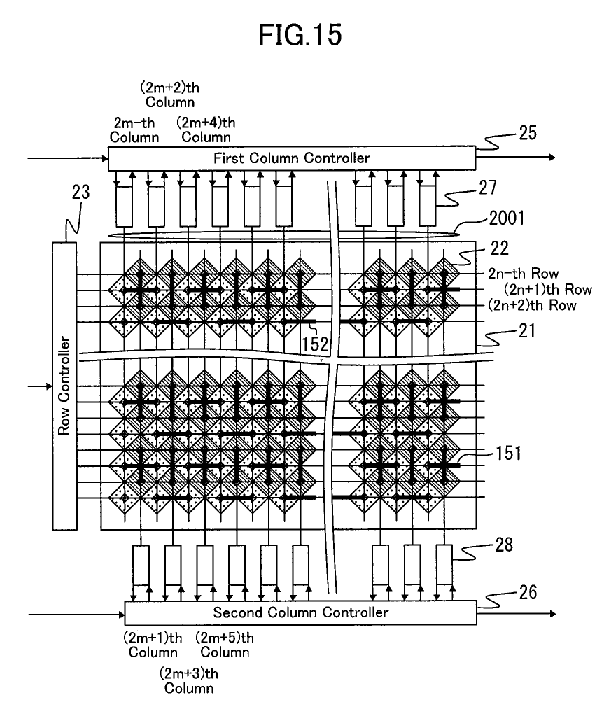

By performing the aforementioned drive operation, pixel binning can be performed in accordance with a pixel binning pattern 151 shown in FIG. 15.

Next, the row controller 23 outputs to the pixels 22 on the (2n+3)th row a row select signal for reading out imaging signals. In accordance with the row select signal, it is determined that imaging signals accumulated in the pixels 22 on the (2n+3)th row are to be read out.

Further, the first column controller 25 outputs a column select signal, so that the imaging signals in the pixels 22 on the (2n+3)th row are output to the first column signal processors 27. The first column signal processors 27 convert the analog imaging signals read from the pixels 22 on the (2n+3)th row to digital signals using the A/D converters 31 before latching the digital signals using the flip-flops 32.

The resultant digital imaging signals originated from the pixels 22 on the (2n+3)th row are transferred by the first column controller 25, which outputs the digital imaging signals as output signals of the image sensor 4. In this case, by inputting a selection control signal so that the outputs of the selectors 1441 in the (4m+2)th column segments invariably have values of the (4m+4)th columns, one of the inputs of each of the adders 1442 in the (4m+2)th column segments is invariably the pixel signal of the corresponding (4m+4)th column. Thereafter, the pixel signals of the (4m+2)th and (4m+4)th columns of interest are added. Thereafter, the output results of the adders 1442 in the (4m+2)th column segments are input to the selectors 1443 in the (4m+2)th column segments.

Every horizontal blanking interval, by controlling the selection control signal to the selectors 1443 in the (4m+2)th column segments during a predetermined period so that the outputs of the adders 1442 in the (4m+2)th column segments are the outputs of selectors 1443 in the (4m+2)th column segments, the results of the addition of the pixel signals of the (4m+2)th columns and the pixel signals of the (4m+4)th columns are input to the flip-flops 1444 in the (4m+2)th column segments.

Thereafter, by controlling the selection control signal so that the outputs of the selectors 1443 in the 4m-th column segments and the outputs of the selectors 1443 in the (4m+2)th column segments are the outputs of the flip-flops 1444 in the (4m+2)th column segments and the outputs of the selectors 1443 in the 4m-th column segments, respectively, the flip-flops 1444 are sequentially coupled. Therefore, the added pixel signals can be read out by applying clocks to perform shift operation.

By performing the aforementioned drive operation, pixel binning can be performed in accordance with a pixel binning pattern 152 shown in FIG. 15. By switching between the addition of pixel signals using the pixel binning pattern 151 of FIG. 15 and the addition of pixel signals using the pixel binning pattern 152 of FIG. 15 every predetermined horizontal blanking interval, pixel binning is carried out as shown in FIG. 15.

<<First Variation of Third Embodiment>>

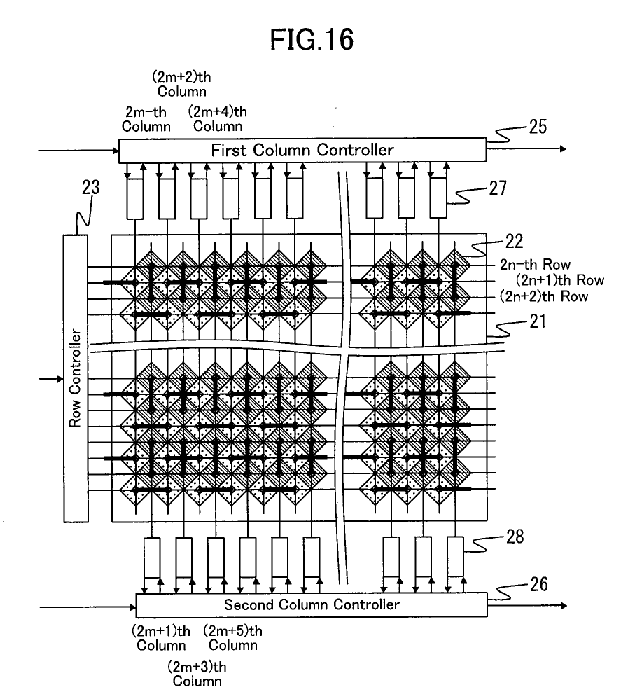

In the foregoing description, when pixel signals are read from the pixels 22 on the image sensor 4, the pixel signals are added in the row direction. Alternatively, the operation of adding the pixel signals of the (2n+1)th row and the operation of adding the pixel signals of the (2n+3)th row may be replaced with those shown in FIG. 16, or the operations of FIGS. 15 and 16 may be switched every predetermined vertical blanking interval.

<<Second Variation of Third Embodiment>>

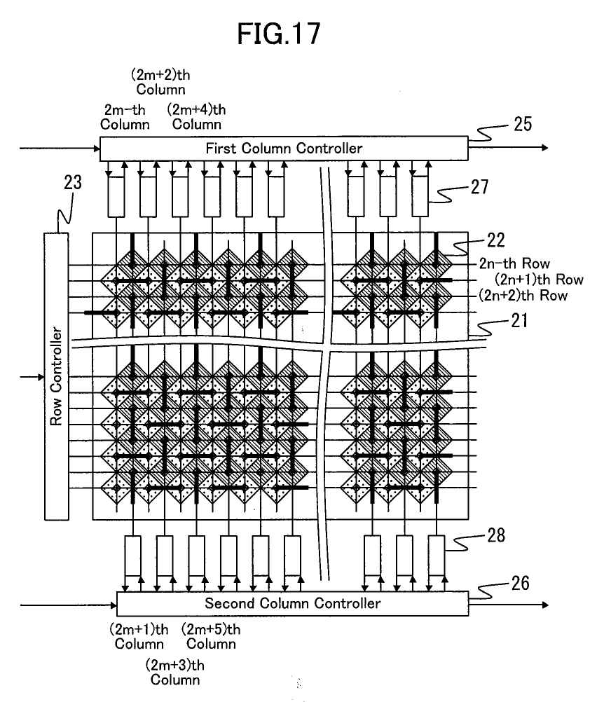

In the foregoing description, the centers of mass of pixels as a result of the addition of the pixels in the row direction have a pixel shift relationship, or the centers of mass of pixels as a result of the addition of the pixels in the column direction have a pixel shift relationship. Alternatively, the aforementioned pixel binning methods may be combined so that the centers of mass of pixels as a result of the addition of the pixels in the row direction have a pixel shift relationship and the centers of mass of pixels as a result of addition of the pixels in the column direction have a pixel shift relationship as shown in FIG. 17.

Moreover, signals may be read from pixels by combining the pixel binning methods every predetermined vertical blanking interval or every predetermined horizontal blanking interval.

<<Third Variation of Third Embodiment>>

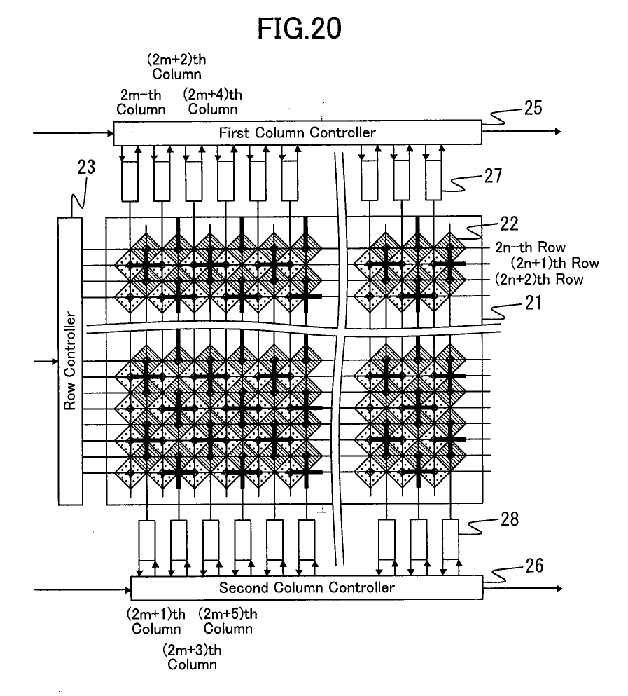

In the foregoing description, the centers of mass of pixels as a result of the addition of the pixels in the row direction have a pixel shift relationship, or the centers of mass of pixels as a result of the addition of the pixels in the column direction have a pixel shift relationship. Alternatively, the aforementioned pixel binning methods may be combined so that the centers of mass of pixels as a result of the addition of the pixels in the row direction coincide with the centers of mass of pixels as a result of the addition of the pixels in the colmn direction as shown in FIG. 20.

Moreover, signals may be read from pixels by combining the pixel binning methods every predetermined vertical blanking interval or every predetermined horizontal blanking interval.

<<Fourth Variation of Third Embodiment>>

In the foregoing description, the number of pixels to be binned is two. Alternatively, the number of pixels to be binned may be increased to three or more by additionally providing a circuit for addition and controlling the drive method. Alternatively, the number of pixels to be binned may be changed between when pixel signals are added in the row direction and when pixel signals are added in the column direction.

Moreover, pixel signals may be added only in the column direction and pixel signals may not be added in the row direction. Alternatively, pixel signals may be added only in the row direction and pixel signals may not be added in the column direction.

<<Fifth Variation of Third Embodiment>>

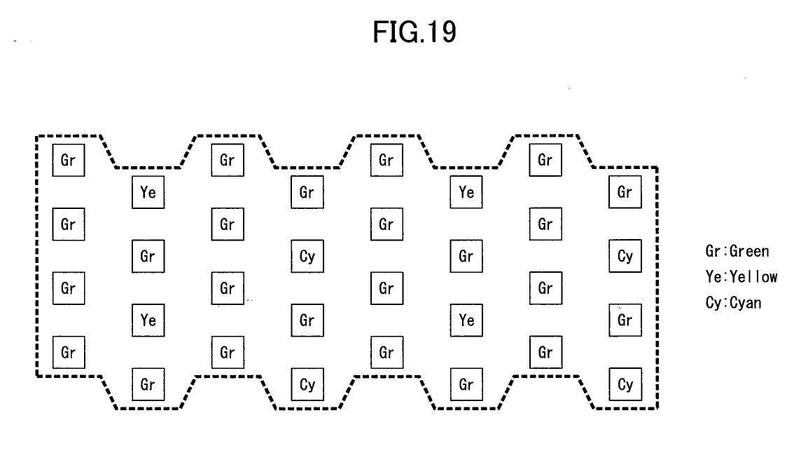

In the foregoing description, the color filters provided on the pixels 22 of the image sensor 4 are those shown in FIG. 7. Alternatively, a color filter array shown in FIG. 19 may be used. In FIG. 19, Gr indicates green, Cy indicates cyan, and Ye indicates yellow.

In this case, when signals are read out with pixel binning, rows including only Gr are selected as ones on which addition is performed in the row direction, and the other rows are selected as ones on which addition is performed in the column direction, whereby pixel signals are binned and output in pairs, i.e., Gr+Gr, Ye+Gr, and Cy+Gr. When signals are read out without pixel binning, pixel signals are output as Gr, Cy, and Ye.

Moreover, positions where addition is performed in the column direction and position where addition is performed in the row direction may be switched.

<<Sixth Variation of Third Embodiment>>

In the foregoing description, the number of the Gr color filters is more than or equal to half of the total. The number of filters of another color may be more than or equal to half of the total.

For example, the number of filters of Ye, R, or the like may be more than or equal to half of the total in applications for subjects in which the red component is predominant, such as endoscopes and the like. Similarly, in applications for subjects in which a specific color component is predominant, color filters which easily transmit light having a wavelength corresponding to the color component may be used.

<<Seventh Variation in Third Embodiment>>

In the foregoing description, the number of the Gr color filters is more than or equal to half of the total. The color modulated components of color filters on only odd-numbered or even-numbered columns on the pixel array 21 all color filters of which have the same color, may be lower than those of color filters having the same color on the other even-numbered or odd-numbered columns. As a result, most of luminance information of a subject may be contained in pixel signals read from the color filters on only the odd-numbered or even-numbered columns on the pixel array 21 all color filters of which have the same color, whereby the resolution and the sensitivity are improved. More specifically, in pixels on the 2n-th and (2n+1)th columns (n is an integer of 0 or more) on which color filters of the same color are provided, the modulated components of the same color on one of the 2n-th column and the (2n+1)th column may be lower than those on the other column. Alternatively, the difference between the maximum transmittance and the minimum transmittance of the normalized filtering characteristic of the color filters corresponding to the same color on the 2n-th column, and the difference between the maximum transmittance and the minimum transmittance of the normalized filtering characteristic of the color filters corresponding to the same color on the (2n+1)th column, may be caused to be different from each other. The transmittance with respect to light other than that which has a major wavelength of the normalized filtering characteristic of the color filters corresponding to the same color on the 2n-th column, and the transmittance with respect to light other than that which has a major wavelength of the normalized filtering characteristic of the color filters corresponding to the same color on the (2n+1)th column, may be caused to be different from each other. The half-width of the transmittance with respect to light which has a major wavelength of the normalized filtering characteristic of the color filters corresponding to the same color on the 2n-th column, and the half-width of the transmittance with respect to light which has a major wavelength of the normalized filtering characteristic of the color filters corresponding to the same color on the (2n+1)th column, may be caused to be different from each other.

<<Eighth Variation of Third Embodiment>>

In the foregoing description, the number of the Gr color filters is more than or equal to half of the total. Alternatively, color filters on only odd-numbered or even-numbered columns on the pixel array 21 all color filters of which have the same color may be caused to have a gray color having substantially a flat spectral characteristic with respect to light entering the pixels 22, or to have substantially the same spectral sensitivity to luminance as that of humans.

Note that when shooting is performed in a visible light region, the gray color filter may have substantially a flat spectral characteristic with respect to wavelengths of about 400 nm to about 700 nm. When shooting is performed in an infrared light region or an ultraviolet light region, or in a region having a specific wavelength range, the gray color filter may have substantially a flat spectral characteristic with respect to the wavelength region.

### Fourth Embodiment of the Invention

An imaging system according to a fourth embodiment of the present disclosure will be described. The imaging system of the fourth embodiment of the present disclosure is slightly different from that of the third embodiment of the present disclosure. Differences will be mainly described. This embodiment is different from the third embodiment in that the CPU 6 controls the number of pixels on the image sensor 4 whose pixel signals are to be binned.

The CPU 6 of this embodiment switches between a mode in which pixel signals are read out with pixel binning and a mode in which pixel signals are read out without pixel binning, for each of the functional blocks provided in the imaging module 2 and the DSP 5, sets a parameter for image processing in the YC processor 10, and the like.

In this embodiment, the CPU 6 notifies the timing generator (TG) (not shown) of the imaging module 2 of the number of pixel signals to be binned, depending on the result of the detection from the level detector 9. The TG generates control pulses for driving the image sensor 4 based on the number of pixel signals to be binned which is notified by the CPU 6.

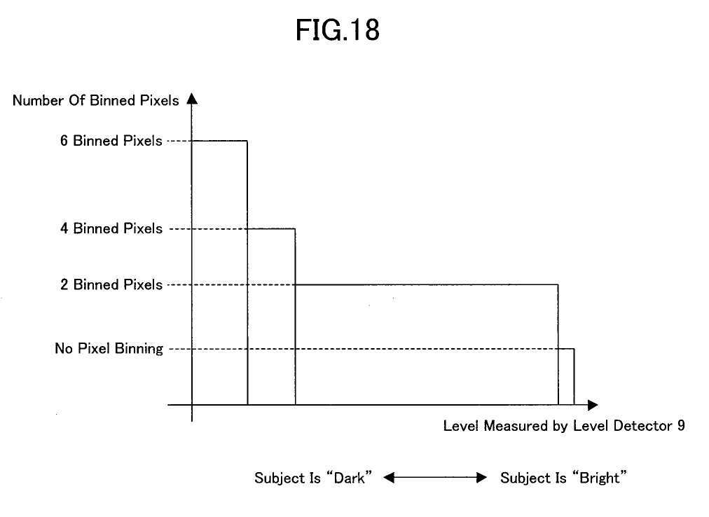

FIG. 18 shows a relationship between the result of the detection by the level detector 9 and the number of pixel signals to be binned, in the imaging system of this embodiment. The horizontal axis indicates the result of the detection by the level detector 9. As one progresses rightward on the horizontal axis, the level of an imaging signal output from the image sensor 4 increases, i.e., the brightness of a subject increases.

As shown in FIG. 18, the CPU 6 divides the brightness of a subject into groups using a plurality of thresholds. Specifically, when the result of the detection by the level detector 9 is smaller than the first threshold, pixel signals of six pixels are binned. When the result of the detection by the level detector 9 is larger than the first threshold and smaller than the second threshold, pixel signals of four pixels are binned. When the result of the detection by the level detector 9 is larger than the second threshold and smaller than the third threshold, pixel signals of two pixels are binned. When the result of the detection by the level detector 9 is larger than the third threshold, pixel signals are read out without pixel binning.

<<First Variation of Fourth Embodiment>>

In the foregoing description, the number of pixel signals to be binned is 6, 4, 2, or 1 pixel. Alternatively, other combinations may be used. Moreover, the number of combinations of pixel signals to be binned may be two or more instead of four.

<<Second Variation of Fourth Embodiment>>

In the foregoing description, the number of pixel signals to be binned by the CPU 6 is determined based only on the result of the detection by the level detector 9. Alternatively, the number of pixel signals to be binned by the CPU 6 may be determined based on a value specified directly by the external input 15, or based on a combination of the value specified by the external input 15 and the result of the detection by the level detector 9. Alternatively, the thresholds may be set by the external input 15.

<<Third Variation of Fourth Embodiment>>

In the foregoing description, the number of pixel signals does not depend on the direction. The number of pixels to be binned may be set in the column direction and the row direction separately.

### Other Embodiments

Note that the foregoing description is not intended to limit the present disclosure. Various changes and modifications can be made without departing from the scope of the present disclosure.

For example, although, in the foregoing description, the image sensor 4 is a CMOS sensor, the image sensor 4 may be a CCD sensor or an NMOS sensor.

Moreover, the unit array of color filters provided in the image sensor 4 is not limited to those described above. The unit array of color filters may be vertically or horizontally reversed, or the color components may be replaced with other sets of color components.

Moreover, although, in the foregoing description, pixel signals are binned after conversion to digital signals, capacitors for binning or averaging pixel signals may be provided on the image sensor 4 to perform the addition in the form of analog signal or electric charge. The binning, addition, or averaging of pixel signals may be performed on the horizontal transfer CCDs, the vertical transfer CCDs, and the like.

Moreover, although, in the foregoing description, the imaging system is a digital camcorder, the imaging system may be an electronic still camera.

The imaging device of the present disclosure has the advantage of improving the resolution, facilitating image processing, and obtaining high-definition moving images even using an imaging sensor having a small number of pixels. The imaging device of the present disclosure is useful for imaging devices which have a large number of pixels in a pixel shift arrangement and in which signals are read out with pixel binning, and imaging modules, electronic still cameras, electronic movie cameras, and the like including the imaging devices.

What is claimed is:

1. An imaging device comprising:
a plurality of pixels arranged in a matrix and each configured to convert incident light to an electric charge signal and output the electric charge signal as a pixel signal, a portion of the pixels being shifted in a row direction from another portion of the pixels; and
a pixel binning unit configured to bin pixel signals from pixels and output the binned pixel signal,
wherein
the pixel binning unit performs first pixel binning operation of binning pixel signals from pixels on the same column and second pixel binning operation of binning pixels on the same row.

2. The imaging device of claim 1, wherein
the pixel binning unit bins pixel signals from pixels adjacent to each other in each of the first and second binning operations.

3. The imaging device of claim 1, wherein
the pixel binning unit bins pixel signals so that a center of mass after pixel binning which is formed by the first pixel binning operation coincides with a center of mass after pixel binning which is formed by the first pixel binning operation with respect to pixels which are adjacent to pixels in the pixel binning pattern and are located on a column adjacent to the pixels in the pixel binning pattern, and a center of mass after pixel binning which is formed by the second pixel binning operation coincides with a center of mass after pixel binning which is formed by the second pixel binning operation with respect to pixels which are adjacent to the pixels in the pixel binning pattern and are located on a row adjacent to the pixels in the pixel binning pattern.

4. The imaging device of claim 1, wherein
the pixel binning unit bins pixel signals so that a center of mass after pixel binning which is formed by the first pixel binning operation is shifted by a predetermined number of pixels in a column direction from a center of mass after pixel binning which is formed by the first pixel binning operation with respect to pixels which are adjacent to pixels in the pixel binning pattern and are located on a column adjacent to the pixels in the pixel binning pattern, and a center of mass after pixel binning which is formed by the second pixel binning operation coincides with a center of mass after pixel binning which is formed by the second pixel binning operation with respect to pixels which are adjacent to the pixels in the pixel binning pattern and are located on a row adjacent to the pixels in the pixel binning pattern.

5. The imaging device of claim 1, wherein
the pixel binning unit bins pixel signals so that a center of mass after pixel binning which is formed by the first pixel binning operation coincides with a center of mass after pixel binning which is formed by the first pixel binning operation with respect to pixels which are adjacent to pixels in the pixel binning pattern and are located on a column adjacent to the pixels in the pixel binning pattern, and a center of mass after pixel binning which is formed by the second pixel binning operation is shifted by a predetermined number of pixels in a row direction from a center of mass after pixel binning which is formed by the second pixel binning operation with respect to pixels which are adjacent to the pixels in the pixel binning pattern and are located on a row adjacent to the pixels in the pixel binning pattern.

6. The imaging device of claim 1, wherein
the pixel binning unit bins pixel signals so that a center of mass after pixel binning which is formed by the first pixel binning operation is shifted by a predetermined number of pixels in a column direction from a center of mass after pixel binning which is formed by the first pixel binning operation with respect to pixels which are adjacent to pixels in the pixel binning pattern and are located on a column adjacent to the pixels in the pixel binning pattern, and a center of mass after pixel binning which is formed by the second pixel binning operation is shifted by a predetermined number of pixels in a row direction from a center of mass after pixel binning which is formed by the second pixel binning operation with respect to pixels which are adjacent to the pixels in the pixel binning pattern and are located on a row adjacent to the pixels in the pixel binning pattern.

7. The imaging device of claim 4, wherein
the shift in the column direction is smaller than a distance between the two centers of mass after pixel binning which are formed by the first pixel binning operation and are located side by side in the column direction.

8. The imaging device of claim 5, wherein
the shift in the row direction is smaller than a distance between the two centers of mass after pixel binning which are formed by the second pixel binning operation and are located side by side in the row direction.

9. The imaging device of claim 6, wherein
the shift in the column direction is smaller than a distance between the two centers of mass after pixel binning which are formed by the first pixel binning operation and are located side by side in the column direction, and
the shift in the row direction is smaller than a distance between the two centers of mass after pixel binning which are formed by the second pixel binning operation and are located side by side in the row direction.

10. The imaging device of claim 1, wherein
the number of pixels to be binned is the same in both the first pixel binning operation and the second pixel binning operation.

11. The imaging device of claim 1, wherein
the number of pixels to be binned in the first pixel binning operation is different from the number of pixels to be binned in the second pixel binning operation.

12. The imaging device of claim 1, wherein
the number of pixels to be binned in the first pixel binning operation and the number of pixels to be binned in the second pixel binning operation are each two.

13. The imaging device of claim 1, wherein
a center of mass of pixels in a vertical direction to be read out by the first pixel binning operation is changed every predetermined vertical blanking interval.

14. The imaging device of claim 1, wherein
a center of mass of pixels in a horizontal direction to be read out by the second pixel binning operation is changed every predetermined vertical blanking interval.

15. The imaging device of claim 1, wherein
in the first or second pixel binning operation, reading out of a signal is skipped for pixels on predetermined rows or columns or at predetermined pixel addresses.

16. The imaging device of claim 1, wherein
a color filter is provided on each of the pixels.

17. The imaging device of claim 16, wherein
the color filters are primary color filters of red, green, and blue.

18. The imaging device of claim 16, wherein
the color filters are complementary color filters of at least three of magenta, green, cyan, and yellow.

19. The imaging device of claim 16, wherein
for pixels which are located on the 2n-th column (n is an integer of 0 or more) or the (2n+1)th column and on which color filters of the same color are provided, a modulated component of the same color on one of the 2n-th and (2n+1)th columns is lower than that on the other column,
a difference between a maximum transmittance and a minimum transmittance of a normalized filtering characteristic of color filters corresponding to the same color on the 2n-th column is different from that of color filters corresponding to the same color on the (2n+1)th column,
a transmittance with respect to light other than light having a major wavelength of the normalized filtering characteristic of color filters corresponding to the same color on the 2n-th column is different from that of color filters corresponding to the same color on the (2n+1)th column, or
a half-width of a transmittance with respect to light other than light having a major wavelength of a normalized filtering characteristic of color filters corresponding to the same color on the 2n-th column is different from that of color filters corresponding to the same color on the (2n+1)th column.

20. The imaging device of claim 16, wherein
the color filters have a gray color, or a luminosity factor characteristic to luminance.

21. The imaging device of claim 16, wherein
the color filters have a repeating pattern of a unit array including four pixels,
a color filter of a first color is provided on a reference pixel on the 2n-th line (n is an integer of 0 or more) of the unit array,
a color filter of the first color is provided on a pixel adjacent to the reference pixel in a first horizontal direction on the 2n-the line of the unit array,
a color filter of a second color is provided on a pixel whose center of mass is shifted by a predetermined fraction of a pixel in the first horizontal direction from the reference pixel on the (2n+1)th line of the unit array, and
a color filter of a third color is provided on a pixel adjacent in the first horizontal direction to the pixel whose center of mass is shifted by the predetermined fraction of a pixel in the first horizontal direction from the reference pixel on the (2n+1)th line of the unit array.

22. The imaging device of claim 16, wherein
the color filters have a repeating pattern of a unit array including eight pixels,
a color filter of a first color is provided on a reference pixel on the 4n-th line (n is an integer of 0 or more) of the unit array,
a color filter of the first color is provided on a pixel having the same center of mass in a horizontal direction as that of the reference pixel on the (4n+2)th line of the unit array,
a color filter of the first color is provided on a pixel adjacent to the reference pixel in a first horizontal direction on the 4n-the line of the unit array,
a color filter of the first color is provided on a pixel having the same center of mass in the horizontal direction as that of the pixel adjacent to the reference pixel in the first horizontal direction on the (4n+2)the line of the unit array,
a color filter of a second color is provided on a pixel whose center of mass is shifted by a predetermined fraction of a pixel in the first horizontal direction from the reference pixel on the (4n+1)th line of the unit array,
a color filter of a third color is provided on a pixel whose center of mass is shifted by a predetermined fraction of a pixel in the first horizontal direction from the reference pixel on the (4n+3)th line of the unit array,
a color filter of the second color is provided on a pixel adjacent in the first horizontal direction to the pixel whose center of Mass is shifted by the predetermined fraction of a pixel in the first horizontal direction from the reference pixel on the (4n+1)th line of the unit array, and
a color filter of the third color is provided on a pixel adjacent in the first horizontal direction to the pixel whose center of mass is shifted by the predetermined fraction of a pixel in the first horizontal direction from the reference pixel on the (4n+3)th line of the unit array.

23. The imaging device of claim 16, wherein
the color filters have a repeating pattern of a unit array including 16 pixels,
a color filter of a first color is provided on a reference pixel on the 8n-th column (n is an integer of 0 or more) of the unit array,
a color filter of the first color is provided on a pixel having the same center of mass in a vertical direction as that of the reference pixel on the (8n+2)th column of the unit array,
a color filter of the first color is provided on a pixel having the same center of mass in the vertical direction as that of the reference pixel on the (8n+4)th column of the unit array,
a color filter of the first color is provided on a pixel having the same center of mass in the vertical direction as that of the reference pixel on the (8n+6)th column of the unit array,
a color filter of the first color is provided on a pixel adjacent in a first vertical direction to the reference pixel on the 8n-th column of the unit array,
a color filter of the first color is provided on a pixel adjacent in the first vertical direction to the pixel having the same center of mass in the vertical direction as that of the reference pixel on the (8n+2)th column of the unit array,
a color filter of the first color is provided on a pixel adjacent in the first vertical direction to the pixel having the same center of mass in the vertical direction as that of the reference pixel on the (8n+4)th column of the unit array,
a color filter of the first color is provided on a pixel adjacent in the first vertical direction to the pixel having the same center of mass in the vertical direction as that of the reference pixel on the (8n+6)th column of the unit array,
a color filter of a second color is provided on a pixel which is shifted by a predetermined fraction of a pixel in the first vertical direction from the reference pixel on the (8n+1)th column of the unit array,
a color filter of a third color is provided on a pixel which is shifted by a predetermined fraction of a pixel in the first vertical direction from the reference pixel on the (8n+3)th column of the unit array,
a color filter of a fourth color is provided on a pixel which is shifted by a predetermined fraction of a pixel in the first vertical direction from the reference pixel on the (8n+5)th column of the unit array,
a color filter of a fifth color is provided on a pixel which is shifted by a predetermined fraction of a pixel in the first vertical direction from the reference pixel on the (8n+7)th column of the unit array,
a color filter of the fourth color is provided on a pixel adjacent in the first vertical direction to the pixel which is shifted by the predetermined fraction of a pixel in the first vertical direction from the reference pixel on the (8n+1)th column of the unit array,
a color filter of the fifth color is provided on a pixel adjacent in the first vertical direction to the pixel which is shifted by the predetermined fraction of a pixel in the first vertical direction from the reference pixel on the (8n+3)th column of the unit array,
a color filter of the second color is provided on a pixel adjacent in the first vertical direction to the pixel which is shifted by the predetermined fraction of a pixel in the first vertical direction from the reference pixel on the (8n+5)th column of the unit array, and
a color filter of the third color is provided on a pixel adjacent in the first vertical direction to the pixel which is shifted by the predetermined fraction of a pixel in the first vertical direction from the reference pixel on the (8n+7)th column of the unit array.

24. The imaging device of claim 16, wherein
the color filters have a repeating pattern of a unit array including 16 pixels,
a color filter of a first color is provided on a reference pixel on the 8n-th line (n is an integer of 0 or more) of the unit array,
a color filter of the first color is provided on a pixel having the same center of mass in a horizontal direction as that of the reference pixel on the (8n+2)th line of the unit array,
a color filter of the first color is provided on a pixel having the same center of mass in the horizontal direction as that of the reference pixel on the (8n+4)th line of the unit array,
a color filter of the first color is provided on a pixel having the same center of mass in the horizontal direction as that of the reference pixel on the (8n+6)th line of the unit array,
a color filter of the first color is provided on a pixel adjacent in a first horizontal direction to the reference pixel on the 8n-th line of the unit array,
a color filter of the first color is provided on a pixel having the same center of mass in the horizontal direction as that of the pixel adjacent in the first horizontal direction to the reference pixel on the (8n+2)th line of the unit array,
a color filter of the first color is provided on a pixel having the same center of mass in the horizontal direction as that of the pixel adjacent in the first horizontal direction to the reference pixel on the (8n+4)th line of the unit array,
a color filter of the first color is provided on a pixel having the same center of mass in the horizontal direction as that of the pixel adjacent in the first horizontal direction to the reference pixel on the (8n+6)th line of the unit array,
a color filter of a second color is provided on a pixel which is shifted by a predetermined fraction of a pixel in the first horizontal direction from the reference pixel on the (8n+1)th line of the unit array,
a color filter of a third color is provided on a pixel which is shifted by a predetermined fraction of a pixel in the first horizontal direction from the reference pixel on the (8n+3)th line of the unit array,
a color filter of a fourth color is provided on a pixel which is shifted by a predetermined fraction of a pixel in the first horizontal direction from the reference pixel on the (8n+5)th line of the unit array,
a color filter of a fifth color is provided on a pixel which is shifted by a predetermined fraction of a pixel in the first horizontal direction from the reference pixel on the (8n+7)th line of the unit array,
a color filter of the fourth color is provided on a pixel adjacent in the first horizontal direction to the pixel which is shifted by the predetermined fraction of a pixel in the first horizontal direction from the reference pixel on the (8n+1)th line of the unit array,
a color filter of the fifth color is provided on a pixel adjacent in the first horizontal direction to the pixel which is shifted by the predetermined fraction of a pixel in the first horizontal direction from the reference pixel on the (8n+3)th line of the unit array,
a color filter of the second color is provided on a pixel adjacent in the first horizontal direction to the pixel which is shifted by the predetermined fraction of a pixel in the first horizontal direction from the reference pixel on the (8n+5)th line of the unit array, and
a color filter of the third color is provided on a pixel adjacent in the first horizontal direction to the pixel which is shifted by the predetermined fraction of a pixel in the first horizontal direction from the reference pixel on the (8n+7)th line of the unit array.

25. The imaging device of claim 21, wherein
for the color filters, the first color is green, the second color is cyan, and the third color is yellow.

26. The imaging device of claim 22, wherein
for the color filters, the first color is green, the second color is cyan, and the third color is yellow.

27. The imaging device of claim 21, wherein
for the color filters, the first color is green, the second color is blue, and the third color is red.

28. The imaging device of claim 22, wherein
for the color filters, the first color is green, the second color is blue, and the third color is red.

29. The imaging device of claim 23, wherein
for the color filters, the first color is green, the second color is green, the third color is yellow, the fourth color is magenta, and the fifth color is cyan.

30. The imaging device of claim 24, wherein
for the color filters, the first color is green, the second color is green, the third color is yellow, the fourth color is magenta, and the fifth color is cyan.

31. The imaging device of claim 23, wherein
for the color filters, the first color is green, the second color is green, the third color is red, the fourth color is green, and the fifth color is blue.

32. The imaging device of claim 24, wherein
for the color filters, the first color is green, the second color is green, the third color is red, the fourth color is green, and the fifth color is blue.

33. The imaging device of claim 16, wherein
color components of color filters for which a first read pixel signal read out by the first pixel binning operation and a second read pixel signal read from a pixel upward or downward adjacent to a pixel of the first read pixel signal by the first pixel binning operation are added, contain magenta, cyan, green, and yellow at a ratio of 1:1:1:1.

34. The imaging device of claim 16, wherein
color components of color filters for which a first read pixel signal read out by the first pixel binning operation and a second read pixel signal read from a pixel upward or downward adjacent to a pixel of the first read pixel signal by the first pixel binning operation are added, contain green, red, and blue at a ratio of 2:1:1.

35. The imaging device of claim 16, wherein
the ratio of the colors of color filters for which a first read pixel signal read out by the first pixel binning operation and a second read pixel signal read from a pixel upward or downward adjacent to a pixel of the first read pixel signal by the first pixel binning operation are added, is the same for all signals read out by the first pixel binning operation.

36. The imaging device of claim 16, wherein
color components of color filters for which a third read pixel signal read out by the second pixel binning operation and a fourth read pixel signal read from a pixel left or right adjacent to a pixel of the first read pixel signal by the second pixel binning operation are added, contain magenta, cyan, green, and yellow at a ratio of 1:1:1:1.

37. The imaging device of claim 16, wherein
color components of color filters for which a third read pixel signal read out by the second pixel binning operation and a fourth read pixel signal read from a pixel left or right adjacent to a pixel of the first read pixel signal by the second pixel binning operation are added, contain green, red, and blue at a ratio of 2:1:1.

38. The imaging device of claim 16, wherein
the ratio of the colors of color filters for which a third read pixel signal read out by the second pixel binning operation and a fourth read pixel signal read from a pixel left or right adjacent to a pixel of the first read pixel signal by the second pixel binning operation are added, is the same for all signals read out by the second pixel binning operation.

39. The imaging device of claim 1, wherein
each of the pixels includes one of a CCD, a CMOS, or an NMOS.

40. The imaging device of claim 1, The imaging device of claim 1, further comprising:
a level detector configured to detect a level of a pixel signal read out from each pixel,
wherein
the pixel binning unit changes the number of pixels to be binned, depending on the pixel signal level detected by the level detector.

41. The imaging device of claim 1, wherein
the pixel binning unit is configured so that the number of pixels to be binned can be externally changed.

42. An imaging module comprising:
the imaging device of claim 1; and
a lens.

43. An electronic still camera comprising:
the imaging module of claim 42; and
a digital signal processing circuit configured to process an imaging signal output from the imaging module.

44. An electronic movie camera comprising:
the imaging module of claim 42; and
a digital signal processing circuit configured to process an imaging signal output from the imaging module.
